(19) United States
(12) Patent Application Publication
(10) Pub. No.: US 2006/0127656 A1
(43) Pub. Date: Jun. 15, 2006

(54) Catalytic membrane reactor

(76) Inventors: Pascal Del Gallo, Dourdan (FR); Gregory Etchegoyen, Rilhac-Rancon (FR); Thierry Chartier, Feytiat (FR)

Correspondence Address: AIR LIQUIDE, 2700 POST OAK BOULEVARD, SUITE 1800, HOUSTON, TX, 77056, US

(21) Appl. No.: 11/049,586

(22) Filed: Feb. 2, 2005

(30) Foreign Application Priority Data
Dec. 10, 2004 (FR) 0452914

(51) Int. Cl. B01J 23/10; B32B 7/02

(52) U.S. Cl. 428/212; 502/303

(57) ABSTRACT

Assembly, characterized in that it comprises either a dense layer (CDI), consisting of a material comprising at least 75% by volume and at most 100% by volume of a compound of formula (I): Mα₁₋ₓ₋ᵤMα′ₓMα″ᵤMβ′_{y}Mβ″ᵥO_{3-w}, a porous layer (C_{P1}), adjacent to the said dense layer (C_{D1}), consisting of a material comprising at least 75% by volume and at most 100% by volume of a compound of formula (II):

Mγ₁₋ₓ₋ᵤMγ⁴⁰ ₓMγ″ᵤMδ_{1-y-v}Mδ′_{y}Mδ″ᵥO_{3-w} and a catalytic layer (C_{C1}), adjacent to the said dense layer (C_{D1}) and consisting of a material comprising at least 75% by volume and at most 100% by volume of a compound of formula (III):

Mε₁₋ₓ₋ᵤMε′ₓMε″ᵤMη_{1-y-v}Mη″ᵥO_{3-w}; or a dense layer (C_{D1}), a porous layer (C_{P1}), a catalytic layer (C_{C1}), of thickness E_{C1}, as defined above; and a second porous layer (C_{P2}), inserted between the said catalytic layer (C_{C1}) and the said dense layer (C_{D1}), consisting of a material comprising at least 75% by volume and at most 100% by volume of a compound of formula (IV): Mθ₁₋ₓ₋ᵤMθ′ₓMθ″ᵤMκ_{1-y-v}Mκ′_{y}Mκ″ᵥO_{3-w}, in which assembly at least two of the chemical elements of adjacent layers are identical and one element is different. Novel reactor intended for the production of syngas by the oxidation of natural gas.

The subject of the invention is a novel catalytic membrane reactor for carrying out electrochemical reactions in the solid state.

A catalytic membrane reactor or CMR for carrying out electrochemical reactions in the solid state must have, in its entirety, the following properties:
it must be capable of catalyzing the chemical reaction for which it has been designed;
it must exhibit ionic, electronic or hybrid conduction properties so as to allow the electrochemical transformations required by the reaction in question; and
it must be stable under the operating conditions employed.

In the case of a CMR intended for the reaction of reforming methane into syngas, the main chemical reaction called catalytic partial oxidation or CPO is:
CH₄+½O₂→2 H₂+CO,
optionally with the intervention of water molecules joining the reducing flow (natural gas) in respect of the steam methane reforming or SMR side reaction. These reactions—main reaction and side reaction—take place at temperatures of between 600° C. and 1100° C., preferably between 650° C. and 1000° C., and at pressures between atmospheric pressure and 40 bar (40×10⁵ Pa), preferably between 10 bar (10⁴ Pa) and 35 bar (35×10⁵ Pa).

The CMR generally consists of at least:

(i) a porous support that provides the system with mechanical integrity;

(ii) a dense membrane (M) called the active membrane, which is supported by the said porous support and is a hybrid electron/O^{2—} anion hybrid conductor; and

(iii) a catalytic phase (C) taking the form either of a porous layer deposited on the surface of the dense membrane, or of catalysts in various geometrical forms, such as rods or spheres that are positioned between the ceramic membranes, or a combination of the two.

In such a reactor, the thick porous support must provide the complete system with sufficient mechanical integrity, must support the dense membrane and must allow gaseous molecular diffusion of the air up to the surface of the membrane and possibly ensure that the oxygen of the air is dissociated into various ionic and/or radical species (O^{2—}, O_{ads}, O^{˜}, O^{—}, O₂^{—}, O₂^{2—}, etc.); the thin dense membrane must be completely impermeable to any gaseous diffusion, must allow, under certain temperature, gaseous atmosphere and partial pressure conditions, the ionic diffusion of oxide species, must be stable in oxidizing medium and in reducing medium (reforming catalyst side) and must possibly exhibit properties on the surface whereby oxygen is reduced to O^{2—} ions and/or O_{2—} ions are oxidized to molecular oxygen; the reforming catalyst (thin porous layer) must accelerate the catalytic natural-gas reforming reaction and possibly promote the recombination of the ionic and/or radical species (O^{2—}, O_{ads}, O^{˜}, O^{—}, O₂^{—}, O₂^{2—}, etc.) into molecular oxygen (O₂). CMRs produced from ceramic materials allow the separation of oxygen from air, by diffusion of this oxygen in ionic form through the dense ceramic material, and the chemical reaction of the oxygen and/or of species of the O^{2—}, O_{ads}, O^{˜}, O^{—}, O₂^{—} or O₂^{2—} type with natural gas, mainly methane, on the catalytic surface sites of the membrane. The conversion of syngas to a liquid fuel by the GTL (Gas To Liquid) process requires a molar ratio of the reactants, H₂/CO of 2. Now, this ratio of 2 may be obtained directly by a process employing a CMR.

The most promising family of materials for use in a CMR is that of oxides having a crystallographic structure derived from perovskite. Perovskite is a mineral of formula CaTiO₃ having a crystal structure in which the unit cell is a cube whose vertices are occupied by the Ca²⁺ cations, its centre by the Ti⁴⁺ cation and the centre of its faces by the O^{2—} oxygen anions. Such a structure is confirmed by X-ray diffraction (XRD). By extension, the term “perovskite” or “perovskite-type compound” applies to any compounds of general formula ABO₃, in which A and B represent metal cations, the sum of the charges of which is equal to +6 and the crystal unit cell of which has the structure described above.

Teraoka was the first to demonstrate the mixed conduction properties of certain perovskite materials such as those of formula: La₁₋ₓSrₓCo_{1-y}Fe_{y}O₃₋₆₇ , i.e. the conduction of electrons (electronic conductivity: σ_{e—}) and the conduction of oxygen ions (ionic conductivity: σₒ^{2—}) [Teraoka et al.; Mat. Res. Bull., 23, (1988) 51-58]. This mixed conduction of a compound of formula A₁₋ₓA′ₓB_{1-y}B′_{y}O₃₋₆₇ , as is attributed to the substitution of the trivalent element A by a bivalent element A′, favouring an oxygen deficit in the material, and by the ability of element B or B′ to change valence state.

Gellings and Bouwmeester have demonstrated that dense membranes of perovskite structure are semi-permeable to oxygen when they are subjected to an oxygen partial pressure difference at temperatures above 700° C. These operating conditions (temperature, atmosphere, pressure) are those of the CPO (catalytic partial oxidation) reaction. These membranes can therefore be used as CMRs [Gellings and Bouwmeester; Catal. Today, 12 (1992) 1-105].

U.S. Pat. Nos. 6,214,757, 5,911,860, 6,165,431 and 5,648,304 disclose materials of perovskite or brown-millerite structure exhibiting mixed conduction, and also their use as catalytic membrane reactor.

To hope to achieve an industrial level of syngas production, the catalytic reactors must be highly permeable to oxygen. Now, the oxygen flux through a membrane is inversely proportional to the thickness of the membrane. It is therefore necessary to minimize the thickness of this dense membrane, typically down to below 300 μm and preferably below 200 μm.

Apart from its mechanical role, the porous support of the CMR may also be “active”, that is to say it may have mixed conduction properties that improve the kinetics for surface exchange between gaseous oxygen and ionic oxygen and therefore improve the oxygen flux through the membrane. In this case, the porous support fulfils not only a mechanical function but also a catalytic fimction of reducing the oxygen in the air to oxide ions (O^{2—}).

The architecture of CMRs, which is defined by the arrangement and the thickness of the various (catalytic, dense and porous) layers, their microstructure, the distribution of pores and the grain size, also has an influence on the oxygen flux. The architecture/microstructure of the CMR also has an influence on the stability of the system under operating conditions. The term “stability” is understood to refer to the thermomechanical properties, creep and degradation phenomena, especially such as interfacial debonding.

U.S. Pat. Nos. 4,791,079 and 4,827,071 disclose the notion of a CMR comprising a porous support having a catalytic activity associated with a dense membrane.

U.S. Pat. No. 5,240,480 discloses several architectures of mixed conductor multilayers, comprising a dense layer associated with a porous layer, the pores of which do not exceed 10 m in size, the two layers being active, that is to say they are composed of oxides having mixed conduction properties, it being possible for the porous layer to have a discrete or continuous porosity gradient. A non-active porous support layer may be affixed to the active porous layer.

U.S. Pat. Nos. 6,368,383 discloses one particular architecture of the membrane, in that it comprises a dense layer, at lease one adjacent active porous layer and at least one non-active porous support layer. That invention demonstrates the influence of the thickness and the microstructure of the active porous layer by defining an optimum pore size/porous layer thickness pair for the oxygen flux through this type of membrane.

United States patents disclose processes for producing a dense/porous bilayer, whether by plasma deposition as in U.S. Pat. No. 5,391,440 and U.S. Pat. No. 6,638,575, by CVD deposition, as in U.S. Pat. No. 5,439,706, or by immersion of a porous body in a suspension of ceramic particles, as in U.S. Pat. No. 5,683,797.

In addition to having a high oxygen flux, the CMR must guarantee (i) an H₂/CO ratio of the order of 2 and (ii) the selectivity of CO relative to CO₂ (a product resulting from the complete combustion of natural gas with oxygen) coming from the CPO reaction. Certain catalysts are capable of favouring the partial oxidation reaction over other reactions (mainly complete combustion)—these are especially the following metals: platinum, palladium, gold, silver, rhodium and nickel, and also their respective oxides or mixtures of their respective oxides. The CMR may thus have a layer of a catalytic material deposited directly on the dense layer or deposited on an intermediate porous layer between the CPO catalyst and the dense membrane. Various CMR architectures have thus been disclosed in U.S. Pat. Nos. 5,534,471 and 5,569,633. The membranes described in those patents comprise a dense mixed conductor layer surrounded, on the one hand, by a porous support and, on the other hand, by a catalytic material, or a porous mixed conductor layer surrounded, on the one hand, by a catalytic layer and, on the other hand, by a dense layer and then, possibly, by a porous support. The porous supports may also be active (acting as oxygen reduction catalyst) but they are not necessarily of perovskite structure. The catalyst is preferably a metal or a metal oxide deposited on the adjacent layer.

Other CMR architectures have been described in U.S. Pat. No. 5,938,822, which comprise one or more thin porous layers deposited on one or more faces of the dense membrane in order to improve the surface reaction kinetics. The dense layer may be a composite produced from a mixed conductor material and from another material that improves the mechanical and catalytic properties or the sintering behaviour of the matrix. The porous material deposited is the same as that of the matrix. This particular architecture may be supplemented with a porous support layer of indeterminate nature for improving the structural stability of the multilayer.

U.S. Pat. No. 6,514,314 discloses a specific choice of materials that characterize the porous support, having ionic conductivity properties and mixed conductivity properties. Again this has an architecture consisting of a thin dense layer deposited on a porous support with a discrete porosity gradient.

U.S. Pat. No. 6,565,632 discloses a tubular overall structure, comprising the inside of the CMR tube, characterized by: (i) an external catalytic porous layer; (ii) a thin dense membrane; and (iii) a ceramic porous “stake” or porous support (skeleton).

This is why the inventors of the present patent application have sought to develop one particular architecture of the CMR that can be defined as being a multilayer membrane with property gradient, most of the constituent materials of the various layers of which have a perovskite-type crystallographic structure. This particular CMR will be characterized from a chemical standpoint by the chemical continuity of the ceramic compounds constituting each layer; the term “chemical continuity” is understood to mean the presence of at least two identical cations in the formulation of the compounds of directly successive layers. The reactor, as has just been defined, will be called a PCMR (Perovskite Catalytic Membrane Reactor).

The subject of the present invention is therefore an organized assembly based on superposed layers of materials of similar chemical nature, characterized in that it comprises:

either:

(a) a dense layer (C_{D1}), with a thickness E_{D1}, the porosity of which does not exceed 5% by volume, the said dense layer (C_{D1}) consisting of a material (A_{D1}) comprising, for 100% of its volume:

(i) at least 75% by volume and at most 100% by volume of a compound (C₁) chosen from doped ceramic oxides which, at the use temperature, are in the form of a crystal lattice with oxide ion vacancies of perovskite phase, of formula (I):
Mα₁₋ₓ₋ᵤ Mα′ₓ Mα″ᵤ Mβ′_{y} Mβ″ᵥ O_{3-w} (I)
in which:
Mα represents an atom chosen from scandium, yttrium or from the family of lanthanides, actinides or alkaline-earth metals;
Mα′, which differs from Mα, represents an atom chosen from scandium, yttrium or from the families of lanthanides, actinides or alkaline-earth metals;
Mα″, which differs from Mα and Mα′, represents an atom chosen from aluminium (Al), gallium (Ga), indium (In), thallium (Ti) or from the family of alkaline-earth metals;
Mβ represents an atom chosen from transition metals;
Mβ′, which is different from Mβ, represents an atom chosen from transition metals, aluminium (Al), indium (In), gallium (Ga), germanium (Ge), antimony (Sb), bismuth (Bi), tin (Sn), lead (Pb) or titanium (Ti);
Mβ″, which differs from Mβ and Mβ′, represents an atom chosen from transition metals, metals of the alkaline-earth family, aluminium (Al), indium (In), gallium (Ga), germanium (Ge), antimony (Sb), bismuth (Bi), tin (Sn), lead (Pb) or titanium (Ti);
0<x≦0.5;
0≦u≦0.5;
(x+u)≦0.5;
0≦y≦0.9;
0≦v≦0.9; 0≦(y+v)≦0.9; and
w is such that the structure in question is electrically neutral;

(ii) optionally up to 25% by volume of a compound (C₂), which differs from compound (C₁), chosen either from oxide-type materials such as boron oxide, aluminium oxide, gallium oxide, cerium oxide, silicon oxide, titanium oxide, zirconium oxide, zinc oxide, magnesium oxide or calcium oxide, preferably from magnesium oxide (MgO), calcium oxide (CaO), aluminium oxide (Al₂O₃), zirconium oxide (ZrO₂), titanium oxide (TiO₂) or ceria (CeO₂); strontium-aluminium mixed oxides SrAl₂O₄ or Sr₃Al₂O₆; barium-titanium mixed oxide (BaTiO₃); calcium-titanium mixed oxide (CaTiO₃); aluminium and/or magnesium silicates, such as mullite (2SiO₂.3Al₂O₃), cordierite (Mg₂Al₄Si₅O₁₈) or the spinel phase MgAl₂O₄; calcium-titanium mixed oxide (CaTiO₃); calcium phosphates and their derivatives, such as hydroxylapatite Ca₁₀(PO₄)₆(OH)₂ or tricalcium phosphate Ca₃(PO₄)₂; or else materials of the perovskite type, such as La_{0.5}Sr_{0.5}Fe_{0.9}Ti_{0.1}O_{3-δ}, La_{0.6}Sr_{0.4}Fe_{0.9}Ga_{0.1}O_{3-δ}, La_{0.5}Sr_{0.5}Fe_{0.9}Ga_{0.1}O_{3-δ} or La_{0.6}Sr_{0.4}Fe_{0.9}Ti_{0.1}O_{3-δ}, or else from materials of the non-oxide type, preferably chosen from carbides or nitrides such as silicon carbide (SiC), boron nitride (BN), aluminium nitride (AIN) or silicon nitride (Si₃N₄), “sialons” (SiAlON), or from nickel (Ni), platinum (Pt), palladium (Pd) or rhodium (Rh); metal alloys or mixtures of these various types of material; and

(iii) optionally up to 2.5% by volume of a compound (C₁₋₂) produced from at least one chemical reaction represented by the equation:
xF_{C1}+yF_{C2}→zF_{C1-2,}
in which equation F_{C1}, F_{C2} and F_{C1-2} represent the respective raw formulae of compounds (C₁), (C₂) and (C₁₋₂) and x, y and z represent rational numbers greater than or equal to 0;

(b) a porous layer (C_{P1}), with a thickness of E_{P1}, the volume porosity of which is between 20% and 80%, adjacent to the said dense layer (C_{D1}), the said porous layer (C_{P1}) consisting of a material (A_{P1}) comprising, per 100% of its volume:

(i) at least 75% by volume and at most 100% by volume of a compound (C₃) chosen from doped ceramic oxides which, at the use temperature, are in the form of a crystal lattice having oxide ion vacancies of perovskite phase, of formula (II):
Mγ₁₋ₓ₋ᵤ Mγ′ₓ Mγ″ᵤ Mδ_{1-y-v} Mδ′_{y} Mδ″ᵥO_{3-w} (II)
in which:
Mγ represents an atom chosen from scandium, yttrium or from families of lanthanides, actinides or alkaline-earth metals;
Mγ′, which differs from Mγ, represents an atom chosen from scandium, yttrium or from families of lanthanides, actinides or alkaline-earth metals;
Mγ″, which differs from Mγ and Mγ′, represents an atom chosen from aluminium (Al), gallium (Ga), indium (In), thallium (Tl) or from the family of alkaline-earth metals;
Mδ represents an atom chosen from transition metals;
Mδ′, which differs from Mδ, represents an atom chosen from transition metals, aluminium (Al), indium (In), gallium (Ga), germanium (Ge), antimony (Sb), bismuth (Bi), tin (Sn), lead (Pb) or titanium (Ti);
Mδ″, which differs from Mδ and Mδ′, represents an atom chosen from transition metals, metals of the alkaline-earth family, aluminium (Al), indium (In), gallium (Ga), germanium (Ge), antimony (Sb), bismuth (Bi), tin (Sn), lead (Pb) or titanium (Ti);
0<x≦0.5;
0≦u≦0.5;
(x+u)≦0.5;
0≦y≦0.9;
0≦v≦0.9;
0≦(y+v)≦0.9; and
w is such that the structure in question is electrically neutral;

(ii) optionally up to 25% by volume of a compound (C₄), which differs from compound (C₃), chosen either from oxide-type materials such as boron oxide, aluminium oxide, gallium oxide, cerium oxide, silicon oxide, titanium oxide, zirconium oxide, zinc oxide, magnesium oxide or calcium oxide, preferably from magnesium oxide (MgO), calcium oxide (CaO), aluminium oxide (Al₂O₃), zirconium oxide (ZrO₂), titanium oxide (TiO₂) or ceria (CeO₂); strontium-aluminium mixed oxides SrAl₂O₄ or Sr₃Al₂O₆; barium-titanium mixed oxide (BaTiO₃); calcium-titanium mixed oxide (CaTiO₃); aluminium and/or magnesium silicates, such as mullite (2SiO₂.3Al ₂O₃), cordierite (Mg₂Al₄Si₅O₁₈) or the spinel phase MgAl₂O₄; calcium-titanium mixed oxide (CaTiO₃); calcium phosphates and their derivatives, such as hydroxylapatite Ca₁₀(PO₄)₆(OH)₂ or tricalcium phosphate Ca₃(PO₄)₂; or else materials of the perovskite type, such as La_{0.5}Sr_{0.5}Fe_{0.9}Ti_{0.1}O_{3-δ}, La_{0.6}Sr_{0.4}Fe_{0.9}Ga_{0.1}O_{3-δ, La}_{0.5}Sr_{0.5}Fe_{0.9}Ga_{0.1}O_{3-δ} or La_{0.6}Sr_{0.4}Fe_{0.9}Ti_{0.1}O_{3-δ}, or else from materials of the non-oxide type, preferably chosen from carbides or nitrides such as silicon carbide (SiC), boron nitride (BN), aluminium nitride (AIN) or silicon nitride (Si₃N₄), “sialons” (SiAlON), or from nickel (Ni), platinum (Pt), palladium (Pd) or rhodium (Rh); metal alloys or mixtures of these various types of material; and

(iii) optionally, up to 2.5% by volume of a compound (C₃₋₄) produced from at least one chemical reaction represented by the equation:
xF_{C3}+yF_{C4}→zF_{C3-4},
in which equation F_{C3}, F_{C4} and F_{C3-4} represent the respective raw formulae of compounds (C₃), (C₄) and (C₃₋₄), and x, y and z represent rational numbers greater than or equal to 0;

(c) and a catalytic layer (C_{C1}), capable of promoting the reaction of partial oxidation of methane by gaseous oxygen to carbon monoxide and hydrogen, the said catalytic layer (C_{C1}), of thickness E_{C1}, having a volume porosity of between 20% and 80%, being adjacent to the said dense layer (C_{D1}) and consisting of a material (A_{C1}) comprising, per 100% of its volume:

(i) at least 10% by volume and at most 100% by volume of a compound (C₅) chosen from doped ceramic oxides which, at the use temperature, are in the form of a crystal lattice having oxide ion vacancies of perovskite phase, of formula (III): in which:
Mε₁₋ₓ₋ᵤ Mε′ₓ Mε″ᵤ Mη_{1-y-v} Mη′_{y} Mη″ᵥ O_{3-w} (II)
in which:
Mε represents an atom chosen from scandium, yttrium or from families of lanthanides, actinides or alkaline-earth metals;
Mε′, which differs from Mε, represents an atom chosen from scandium, yttrium or from families of lanthanides, actinides or alkaline-earth metals;
Mε″, which differs from Mε and from Mε′, represents an atom chosen from aluminium (Al), gallium (Ga), indium (In), thallium (Ti) or from the family of alkaline-earth metals;
Mη represents an atom chosen from transition metals;
Mη′, which differs from Mη, represents an atom chosen from transition metals, aluminium (Al), indium (In), gallium (Ga), germanium (Ge), antimony (Sb), bismuth (Bi), tin (Sn), lead (Pb) or titanium (Ti);
Mη″, which differs from Mη and from Mη′, represents an atom chosen from transition metals, metals from the alkaline-earth family, aluminium (Al), indium (In), gallium (Ga), germanium (Ge), antimony (Sb), bismuth (Bi), tin (Sn), lead (Pb) or titanium (Ti);
0<x≦0.5;
0≦u≦0.5;
(x+u)≦0.5;
0≦y≦0.9;
0≦v≦0.9;
0≦(y+v)≦0.9; and
w is such that the structure in question is electrically neutral;

(ii) optionally up to 90% by volume of a compound (C₆), which differs from compound (C₅), chosen from nickel (Ni), iron (Fe), cobalt (Co), palladium (Pd), platinum (Pt), rhodium (Rh), ruthenium (Ru) or a mixture of these metals, optionally deposited on an oxide or non-oxide ceramic support, in an amount from 0.1% to 60% by weight of the said metal or of the mixture of metals, the said ceramic supports being chosen: either from oxide-type materials such as boron oxide, aluminium oxide, cerium oxide, silicon oxide, titanium oxide, zirconium oxide, zinc oxide, magnesium oxide or calcium oxide, preferably from magnesium oxide (MgO), calcium oxide (CaO), aluminium oxide (Al₂O₃), zirconium oxide (ZrO₂), titanium oxide (TiO₂) or ceria (CeO₂); aluminium and/or magnesium silicates, such as mullite (2SiO₂.3Al₂O₃), cordierite (Mg₂Al₄Si₅O₁₈) or the spinel phase MgAl₂O₄; calcium-titanium mixed oxide (CaTiO₃) or calcium-aluminium mixed oxide (CaAl₁₂O₁₉); calcium phosphates and their derivatives, such as hydroxylapatite Ca₁₀(PO₄)₆(OH)₂ or tricalcium phosphate Ca₃(PO₄)₂; or else materials of the perovskite type, such as La_{0.5}Sr_{0.5}Fe_{0.9}Ti_{0.1})_{3-δ}, La_{0.6}Sr_{0.4}Fe_{0.9}Ga_{0.1}O_{3-δ}, La_{0.5}Sr_{0.5}Fe_{0.9}Ga_{0.1}O_{3-δ} or La_{0.6}Sr_{0.4}Fe_{0.9}Ti_{0.1}O_{3-δ};

or else from materials of the non-oxide type, preferably chosen from carbides or nitrides such as silicon carbide (SiC), boron nitride (BN), aluminium nitride (AIN) or silicon nitride (Si₃N₄), sialons (SiAlON);

(iii) optionally up to 2.5% by volume of a compound (C₅₋₆) produced from at least one chemical reaction represented by the equation:
xF_{C5}+yF_{C6}→zF_{C5-6},
in which equation F_{C5}, F_{C6} and F_{C5-6}, represent the respective raw formulae of compounds (C₅), (C₆) and (C₅₋₆), and x, y and z represent rational numbers greater than or equal to 0; so as to constitute an assembly E₁consisting of three successive layers {(C_{C1}), (C_{D1}), (C_{P1})}, in which:
at least two of the chemical elements Mα, Mα′, Mα″, Mβ, Mβ′ or M⊖″ actually present in compound (C₁), are identical to two of the chemical elements Mε, Mε′, Mε″, Mη, Mη′ or Mη″ actually present in compound (C₅);
at least one of the chemical elements, Mα, Mα′, Mα″, Mβ, Mβ′ or Mβ″, actually present in compound (C₁), is different from one of the chemical elements Mε, Mε′, Mε″, Mη, Mη′ or Mη″ actually present in compound (C₅);
at least two of the chemical elements Mα, Mα′, Mα″, Mβ, Mβ′ or Mβ″ actually present in compound (C₁) are identical to two of the chemical elements Mγ, Mγ40 , Mγ″, Mδ, Mδ′ or Mδ″ actually present in compound (C₃); and
at least one of the chemical elements Mα, Mα′, Mα″, Mβ, Mβ′ or Mβ″, actually present in compound (C₁) is different from one of the chemical elements Mγ, Mγ′, Mγ″, Mδ, Mδ′ or Mδ″ actually present in compound (C₃); or:

(a) a dense layer (C_{D1}), of thickness E_{D1}, as defined above;

(b) a porous layer (C_{P1}), of thickness E_{P1}, as defined above, adjacent to the said dense layer (C_{D1});

(c) a catalytic layer (C_{C1}), of thickness E_{C1}, as defined above; and

(d) a second porous layer (C_{P2}), of thickness E_{P2}, the volume porosity of which is between 20% and 80%, inserted between the said catalytic layer (C_{C1}) and the said dense layer (C_{D1}), the said porous layer (C_{P2}) consisting of a material (A_{P2}) comprising, per 100% of its volume:

(i) at least 75% by volume and at most 100% by volume of a compound (C₇) chosen from doped ceramic oxides which, at the use temperature, are in the form of a crystal lattice having oxide ion vacancies of perovskite phase, of formula (IV):
Mθ₁₋ₓ₋ᵤ Mθ′ₓ Mθ″ᵤ Mκ_{1-y-v} Mκ′_{y} Mκ″ᵥO_{3-w} (IV)
in which:
Mθ represents an atom chosen from scandium, yttrium or from families of lanthanides, actinides or alkaline-earth metals;
Mθ′, which differs from Mθ, represents an atom chosen from scandium, yttrium or from families of lanthanides, actinides or alkaline-earth metals;
Mθ″, which differs from Mθ and from Mθ′, represents an atom chosen from aluminium (Al), gallium (Ga), indium (In), thallium (Tl) or from the family of alkaline-earth metals;
Mκ represents an atom chosen from transition metals;
Mκ′, which differs from Mκ, represents an atom chosen from transition metals, aluminium (Al), indium (In), gallium (Ga), germanium (Ge), antimony (Sb), bismuth (Bi), tin (Sn), lead (Pb) or titanium (Ti);
Mκ″, which differs from Mκ and from Mκ′, represents an atom chosen from transition metals, metals from the alkaline-earth family, aluminium (Al), indium (In), gallium (Ga), germanium (Ge), antimony (Sb), bismuth (Bi), tin (Sn), lead (Pb) or titanium (Ti);
0<x<0.5;
0≦u≦0.5;
(x+u)≦0.5;
0≦y≦0.9;
0≦v≦0.9;
0≦(y+v)≦0.9; and
w is such that the structure in question is electrically neutral;

(ii) optionally up to 25% by volume of a compound (C₈), which differs from compound (C₇), chosen either from oxide-type materials such as boron oxide, aluminium oxide, gallium oxide, cerium oxide, silicon oxide, titanium oxide, zirconium oxide, zinc oxide, magnesium oxide or calcium oxide, preferably from magnesium oxide (MgO), calcium oxide (CaO), aluminium oxide (Al₂O₃), zirconium oxide (ZrO₂), titanium oxide (TiO2) or ceria (CeO₂); strontium-aluminium mixed oxides SrAl₂O₄ or Sr₃Al₂O₆; barium-titanium mixed oxide (BaTiO₃); calcium-titanium mixed oxide (CaTiO₃); aluminium and/or magnesium silicates, such as mullite (2SiO₂.3Al₂O₃), cordierite (Mg₂Al₄Si₅O₁₈) or the spinel phase MgAl₂O₄; calcium-titanium mixed oxide (CaTiO₃); calcium phosphates and their derivatives, such as hydroxylapatite Ca₁₀(PO₄)₆(OH)₂ or tricalcium phosphate Ca₃(PO₄)₂; or else materials of the perovskite type, such as La_{0.5}Sr_{0.5}Fe_{0.9}Ti_{0.1}O_{3-δ}, La_{0.6}Sr_{0.4}Fe_{0.9}Ga_{0.1}O_{3-δ}, La_{0.5}Sr_{0.5}Fe0.9Ga_{0.1}O_{3-δ} or La_{0.6}Sr_{0.4}Fe_{0.9}Ti_{0.1}O_{3-δ}, or else from materials of the non-oxide type, preferably chosen from carbides or nitrides such as silicon carbide (SiC), boron nitride (BN), aluminium nitride (AIN) or silicon nitride (Si₃N₄), “sialons” (SiAlON), or from nickel (Ni), platinum (Pt), palladium (Pd) or rhodium (Rh); metal alloys or mixtures of these various types of material; and

(iii) optionally up to 2.5% by volume of a compound (C₇₋₈) produced from at least one chemical reaction represented by the equation:
xF_{C7}+yF_{C8}→zF_{C7-8},
in which equation F_{C7}, F_{C8} and F_{C7-8}, represent the respective raw formulae of compounds (C₇), (C₈) and (C₇₋₈) and x, y and z represent rational numbers greater than or equal to 0, so as to constitute an assembly E₂ consisting of four successive layers {(C_{C1}), (C_{P2}), (C_{D1}), (C_{P1})} in which:
at least two of the chemical elements Mθ, Mθ′, Mθ″, Mκ, Mκ′ or Mκ″ actually present in compound (C₇) are identical to two of the chemical elements Mε, Mε′, Mε″, Mη, Mη′ or Mη″ actually present in compound (C₅);
at least one of the chemical elements Mθ, Mθ′, Mθ″, Mκ, Mκ′ or Mκ″, actually present in the compound (C₇) is different from one of the chemical elements Mε, Mε′, Mε″, Mη, Mη′ or MΘ″ actually present in compound (C₅);
at least two of the chemical elements Mα, Mα′, Mα″, Mβ, Mβ′ or Mβ″ actually present in compound (C₁) are identical to two of the chemical elements Mθ, Mθ′, Mθ″, Mκ, Mκ′ or Mκ″ actually present in compound (C₇);
at least one of the chemical elements Mα, Mα′, Mα″, Mβ, Mβ′ or Mβ″ actually present in compound (C₁) is different from one of the chemical elements Mθ, Mθ′, Mθ″, Mκ, Mκ′ or Mκ″ actually present in compound (C₇);
at least two of the chemical elements Mα, Mα′, Mα″, Mβ, Mβ′ or Mβ″ actually present in compound (C₁) are identical to two of the chemical elements Mγ, Mγ′, Mγ″, Mδ, Mδ′ or Mδ″ actually present in compound (C₃); and
at least one of the chemical elements Mα, Mα′, Mα″, Mβ, Mβ′ or Mβ″ actually present in compound (C₁) is different from one of the chemical elements Mγ, Mγ′, Mγ″, Mδ, Mδ′ or Mδ″ actually present in compound (C₃).

In the assembly defined above, the thickness E_{D1} of the dense layer _{CD1} is less than or equal to 500 μm, more particularly less than or equal to 300 μm and preferably less than or equal to 250 μm. This thickness E_{D1} is also generally greater than or equal to 10 μm and preferably greater than or equal to 50 μm.

The thickness E_{P1} of the porous layer C_{P1} and, where appropriate, the thickness E_{P2} of the porous layer C_{P2} are less than or equal to 10⁴ μm and preferably less than or equal to 5×10³ μm. These thicknesses are generally greater than or equal to 10 pm and preferably greater than or equal to 500 μm.

The thickness E_{C1} of the catalytic layer C_{C1} is less than or equal to 10⁴ μm, more particularly less than or equal to 10³ μm and preferably less than or equal to 500 μm. This thickness E_{C1} is generally greater than or equal to 1 μm and preferably greater than or equal to 5 μm.

In the definition of the dense layer C_{D1}, the expression “porosity less than or equal to 5% by volume” is understood to mean that the dense layer is completely impermeable to gas. In this case the porosity is said to be “closed” (no interconnection between the pores). The porosity is measured by mercury porous symmetry in the case of interconnected open porosity and by image analysis using scanning electron microscopy or by density measurement in the case of closed porosity.

In the definition of the porous layers C_{P1} and C_{P2} and of the catalytic layer C_{C1}, the expression “volume porosity between 20% and 80%” is understood to mean that, after sintering, the material undergoes a mercury porous symmetry measurement, the result of which shows a porosity value between 20% and 80% (in this case, interconnected open porosity). This mercury porous symmetry analysis is supplemented by image analysis of micrographs obtained by scanning electron microscopy.

Preferably, the total open porosity of the porous layers C_{P1} and C_{P2} is between 30% and 70%.

The pore size (diameter) is between 0.1 μm and 50 μm, and is preferably between 0.1 and 20 μm.

Preferably, the catalytic layer C_{C1} has a porosity not less than 30% and not exceeding 50%.

In the catalytic layer C_{C1}, the pore size is between 0.1 μm and 50 μm and is preferably between 0.1 μm and 20 μm.

In the organized assembly as defined above, the grains of compounds (C₂), (C₄), (C₆) and (C₈) optionally present in materials (A_{D1}), (A_{P1}), (A_{C1}) and (A_{P2}) respectively, are equiaxed with a diameter of between 0.1 μm and 5 μm and preferably less than 1 μm; the volume proportions of compounds (C₁₋₂), (C₃₋₄), (C₅₋₆) and (C₇₋₈) optionally present in the materials (A_{D1}), (A_{P1}), (A_{C1}) and (A_{P2}) respectively are more particularly less than or equal to 1.5% and even more particularly less than or equal to 0.5% by volume. Frequently, they tend towards 0 if the chemical reactivity between the predominant material and the dispersoid is low.

In the organized assembly based on superposed layers of materials of similar chemical nature, as defined above, the volume proportions of compounds (C₂), (C₄), (C₆) and (C₈) optionally present in the materials (A_{D1}), (A_{P1}), (A_{C1}) and (A_{P2}) are more particularly greater than or equal to 0.1% and less than or equal to 10%, and preferably greater than or equal to 1% and less than or equal to 5%.

In the organized assembly based on superposed layers of materials of similar chemical nature, as defined above, compound (C₁) is more particularly chosen: from compounds of formula (Ia):
La₁₋ₓ₋ᵤMα′ₓMα″ᵤMβ′_{y}Mβ″ᵥO_{3-w} (Ia),
corresponding to formula (I), in which Mα represents a lanthanum atom; from compounds of formula (Ib):
Mα₁₋ₓ₋ᵤSrₓMα″ᵤMβ_{1-y-v}Mβ′_{y}Mβ″ᵥO_{3-w} (Ib),
corresponding to formula (II), in which Mα′ represents a strontium atom; from compounds of formula (Ic):
Mα₁₋ₓ₋ᵤMα′ₓMα″ᵤFe_{1-y-v}Mβ′_{y}Mβ″ᵥO_{3-w} (Ic),
corresponding to formula (I), in which Mβ represents an iron atom; from compounds of formula (Id):
Mα₁₋ₓ₋ᵤMα′ₓMα″ᵤTi_{1-y-v}Mβ′_{y}Mβ″ᵥO_{3-w} (Id),
corresponding to formula (I), in which Mβ represents a titanium atom; or from compounds of formula (Ie):
Mα₁₋ₓ₋ᵤMα′ₓMα″ᵤGa_{1-y-v}Mβ′_{y}Mβ″ᵥO_{3-w} (Ie),
corresponding to formula (I), in which Mβ represents a gallium atom.

Among these, compound (C₁) is preferably chosen: from compounds of formula (If):
La₁₋ₓ₋ᵤSrₓMα″ᵤFe_{1-y-v}Mβ′_{y}Mβ″ᵥO_{3-w} (If),
corresponding to formula (I) in which Mα represents a lanthanum atom, Mα′ represents a strontium atom and Mβ represents an iron atom; from compounds of formula (Ig):
La₁₋ₓ₋ᵤSrₓMα″ᵤTi_{1-y-v}Mβ′_{y}Mβ″ᵥO_{3-w} (Ig),
corresponding to formula (I) in which Mα represents a lanthanum atom, Mα′ represents a strontium atom and Mβ represents a titanium atom; or from compounds of formula (Ih):
La₁₋ₓ₋ᵤSrₓMα″ᵤGa_{1-y-v}Mβ′_{y}Mβ″ᵥO_{3-w} (Ih),
corresponding to formula (I) in which Mα represents a lanthanum atom, Mα′ represents a strontium atom and Mβ represents a gallium atom; from compounds of formula (Ii):
L₁₋ₓ₋ᵤMα′ₓAlᵤFe_{1-y-v}Mβ′_{y}Mβ″ᵥO_{3-w} (Ii),
corresponding to formula (Ia) in which Mα″ represents an aluminium atom and Mβ represents an iron atom; from compounds of formula (Ij):
La₁₋ₓ₋ᵤCaₓMα″ᵤFe_{1-y-v}Mβ′_{y}Mβ″ᵥO_{3-w} (Ij),
corresponding to formula (Ia) in which Mα′ represents a calcium atom and Mβ represents an iron atom; or from compounds of formula (Ik):
La₁₋ₓ₋ᵤBaₓMα″ᵤFe_{1-y-v}Mβ′_{y}Mβ″ᵥO_{3-w} (Ik),
corresponding to formula (Ia) in which Mα′ represents a barium atom and Mβ represents an iron atom.

Among these compounds, there are, for example, those of formulae: La₁₋ₓ₋ᵤSrₓAlᵤFe_{1-y}Ti_{y}O_{3-w}, La₁₋ₓ₋ᵤSrₓCaᵤFe_{1-y}Ti_{y}O_{3-w}, La₁₋ₓ₋ᵤSrₓBaᵤFe_{1-y}Ti_{y}O_{3-w}, La₁₋ₓ₋ᵤSrₓAlᵤFe_{1-y}GaᵥO_{3-w}, La₁₋ₓ₋ᵤSrₓCaᵤFe_{1-y}Ga_{y}O_{3-w}, La₁₋ₓ₋ᵤSrᵤBaᵤFe_{1-y}Ga_{y}O_{3-w}, La₁₋ₓSrₓFe_{1-y}Ti_{y}O_{3-w}, La₁₋ₓSrₓFe_{1-y}GaᵥO_{3-w}, La₁₋ₓ₋ᵤSrₓCaᵤFeO_{3-w}, L₁₋ᵤCaᵤFeO_{3-w} or La₁₋ₓSrₓFeO_{3-w},

and more particularly those of formulae: La_{0.6}Sr_{0.4}Fe_{0.9}Ga_{0.1}O_{3-w}, or La_{0.5}Sr_{0.5}Fe_{0.9}Ti_{0.1}O_{3-w}.

In the organized assembly based on superposed layers of materials of similar chemical nature, as defined above, compound (C₃) is more particularly chosen: from compounds of formula (IIa):
La₁₋ₓ₋ᵤMγ′ₓMγ″ᵤMδ₁₋ₓ₋ᵤMδ′_{y}Mδ″ᵥO_{3-w} (IIa),
corresponding to formula (II) in which Mγ represents a lanthanum atom; from compounds of formula (IIb):
Mγ₁₋ₓ₋ᵤSrₓMγ′ᵤMδ′_{y}Mδ″ᵥO_{3-w}, (IIb),
corresponding to formula (II) in which Mα′ represents a strontium atom; or from compounds of formula (IIc):
Mγ₁₋ₓ₋ᵤMγ′ₓMα″ᵤFe_{1-y-v}Mδ′_{y}Mδ″ᵥO_{3-w}, (IIc),
corresponding to formula (II) in which Mδ represents an iron atom.

Among these, compound (C₃) is preferably chosen:
from compounds of formula (IId):
   La₁₋ₓ₋ᵤSrₓMγ″ᵤFe_{1-y-v}Mδ′_{y}Mδ″ᵥO_{3-w} (IId),
   corresponding to formula (IIa) in which Mγ′ represents a strontium atom and Mδ represents an iron atom;
from compounds of formula (Ile):
   La₁₋ₓ₋ᵤMγ′ₓAlᵤFe_{1-y-v}Mδ′_{y}Mδ″ᵥO_{3-w} (IIe),
   corresponding to formula (IIa) in which Mγ″ represents an aluminium atom and Mκ represents an iron atom;
from compounds of formula (Ilf):
   La₁₋ᵤSrᵤFe_{1-y}Mδ′_{y}O_{3-w} (IIf),
   corresponding to formula (IIa) in which Mγ′ represents a strontium atom, Mδ represents an iron atom and x and v are equal to 0;
from compounds of formula (IIg):
   La₁₋ᵤCaᵤFe_{1-y}Mδ′_{y}O_{3-w} (IIg),
   corresponding to formula (IIa) in which Mγ′ represents a calcium atom, Mδ represents an iron atom and x and v are equal to 0;
from compounds of formula (IIh):
   La₁₋ᵤBaᵤFe_{1-y}Mδ′_{y}O_{3-w} (IIh),
   corresponding to formula (IIa) in which Mγ′ represents a barium atom, Mδ represents an iron atom and x and v are equal to 0;
from compounds of formula (IIi):
   La₁₋ₓ₋ᵤSrₓCa″ᵤFe_{1-y-v}Mδ′_{y}Mδ″ᵥO_{3-w}, (IIi),
   corresponding to formula (IId) in which Mγ″ represents a calcium atom;
or from compounds of formula (IIj):
   La₁₋ₓ₋ᵤSrₓBa″ᵤFe_{1-y-v}Mδ′_{y}Mδ″ᵥO_{3-w} (IIj)
   corresponding to formula (IId) in which Mγ″ represents a barium atom.

Among these compounds, there are, for example, compounds of formulae: L₁₋ₓSrₓFe_{1-y}GaᵥO_{3-w}, La₁₋ₓSrₓFe_{1-y}Ti_{y}O_{3-w}, La₁₋ₓSrₓFeO_{3-w}, La₁₋ᵤCaᵤFe_{1-y}Gaᵥ0_{3-w}, La₁₋ᵤCaᵤFe_{1-y}Ti_{y}O_{3-w}, La₁₋ᵤCaᵤFeO_{3-w}, La₁₋ᵤBaᵤFe_{1-y}GaᵥO_{3-w}, La₁₋ᵤBaᵤFe_{1-y}Ti_{y}O_{3-w}, La₁₋ᵤBaᵤFeO_{3-w}, La₁₋ₓ₋ᵤSrₓAlᵤFe_{1-y}Ti_{y}O_{3-w}, La₁₋ₓ₋ᵤSrₓCaᵤFe_{1-y}Ti_{y}O_{3-w}, La₁₋ₓ₋ᵤSrₓBaᵤFe_{1-y}Ti_{y}O_{3-w}, La₁₋ₓ₋ᵤSrₓAlᵤFe_{1-y}GaᵥO_{3-w}, La₁₋ₓ₋ᵤSrₓCaᵤFe_{1-y}GaᵥO_{3-w}, La₁₋ₓ₋ᵤSrₓBaᵤFe_{1-y}GaᵥO_{3-w}, La₁₋ᵤSrₓFe_{1-y}Ti_{y}O_{3-w}, La₁₋ᵤCaᵤFe_{1-y}Ti_{y}O_{3-w}, La₁₋ᵤBaᵤFe_{1-y}Ti_{y}O_{3-w}, La₁₋ₓSrₓFe_{1-y}GaᵥO_{3-w}, La₁₋ᵤCaᵤFe_{1-y}GaᵥO_{3-w}, La₁₋ᵤBaᵤFe_{1-y}GaᵥO_{3-w}, La₁₋ᵤBaᵤFeO_{3-w}, La₁₋ᵤCaᵤFeO_{3-w} or La₁₋ₓSrₓFeO_{3-w}, and more particularly those of formulae: La_{0.6}Sr_{0.4}Fe_{0.9}Ga_{0.1}O_{3-w}, La_{0.9}Sr_{0.1}Fe_{0.9}Ga_{0.1}O_{3-w}, La_{0.5}Sr_{0.5}Fe_{0.9}Ti_{0.1}O_{3-w}, La_{0.9}Sr_{0.2}Fe_{0.9}Ti_{0.1}O_{3-w}, La_{0.6}Sr_{0.4}Fe_{0.2}Co_{0.8}o_{3-w} or La_{0.9}Sr_{0.1}Feo_{0.2}Co_{0.8}O_{3-w}.

In the organized assembly based on superposed layers of materials of similar chemical nature, as defined above, compound (C₅) is more particularly chosen:
from compounds of formula (IIIa):
   Mε₁₋ₓ₋ᵤMε′ₓMε″ᵤMη_{1-x-y}Ni_{y}RhᵥO_{3-w} (IIIa)
   corresponding to formula (III) in which Mη′, represents a nickel atom and Mη″ represents a rhodium atom;
or from compounds of formula (IIIb):
   La₁₋ₓ₋ᵤSrₓMε″ᵤFe_{1-y-v}Mη′_{y}Mη″ᵥO_{3-w} (IIIb)
   corresponding to formula (III) in which Mε represents a lanthanum atom, Mε′ represents a strontium atom and Mq represents an iron atom.

Among these, compound (C₅) is preferably chosen from compounds of formulae:
La_{1-c}CeₓFe_{1-y-v}Ni
and more particularly those of formulae: Lao.8CeO.₂Feo.₆₅NiO.₃ORho.0₅0₃-w, Lao.8CeO.₂Feo.₇NiO.₃0₃-w, LaO.8Sro.₂Feo.₆₅NiO.₃0h.0₅03-w and Lao.8SrO.₂Feo.₇NiO.₃0₃-w.

In the organized assembly based on superposed layers of materials of similar chemical nature, as defined above, compound (C₇) is more particularly chosen:
from compounds of formula (IVa):

corresponding to formula (IV) in which MO represents a lanthanum atom;

from compounds of formula (IVb):

MO-,ur,O,,M K I-y-vMK'yMK″vO3-8 (lVb), corresponding to formula (IV) in which MO'represents a strontium atom; or from compounds of formula (IVc):

MO-,uM O',Muely-vMK'yMK″vO3.8 (IVc), corresponding to formula (IV) in which MK represents an iron atom.

Among these, compound (C₇) is preferably chosen:

from compounds of formula (IVd):

corresponding to formula (lVa) in which MO'represents a strontium atom and MK represents an iron atom;
from compounds of formula (IVe):
   La₁₋ₓ₋ᵤMθ′ₓAlᵤFe_{1-y-v}Mκ′_{y}Mκ″ᵥO_{3-w} (IVe),
   corresponding to formula (IVa) in which Mθ″ represents an aluminium atom and Mκ represents an iron atom;
from compounds of formula (IVf):
   La₁₋ᵤSrᵤFe_{1-y}Mκ′_{y}O_{3-w} (IVf),
   corresponding to formula (IVa) in which Mθ′ represents a strontium atom, Mκ represents an iron atom and x and v are equal to 0;
from compounds of formula (IVg):
   La₁₋ᵤCaᵤFe_{1-y}Mκ′_{y}O_{3-w} (IVg),
   corresponding to formula (IVa) in which Mθ′ represents a calcium atom, Mκ represents an iron atom and x and v are equal to 0;
from compounds of formula (IVh):
   La₁₋ᵤBaᵤFe_{1-y}Mκ′_{y}O_{3-w} (IVh),
   corresponding to formula (IVa) in which Mθ′ represents a barium atom, Mκ represents an iron atom and x and v are equal to 0;
from compounds of formula (IVi):
   La₁₋ₓ₋ᵤSrₓCa″ᵤFe_{1-y-v}Mκ′_{y}Mκ″ᵥO_{3-w} (IVi),
   corresponding to formula (IVh) in which Mθ″ represents a calcium atom;
or from compounds of formula (IVj):
   La₁₋ₓ₋ᵤSrₓBa″ᵤFe_{1-y-v}Mκ′_{y}Mκ″ᵥO_{3-w} (IVj),
   corresponding to formula (IVd) in which Mθ″ represents a barium atom.

Among these compounds, there are, for example, compounds of formula: La, xSr,Fel-yGaV03-W, La,-,Sr,Fei-yTiyO3-. La, XSrxFeO3-W, La,-,Ca,Fel-yGaVO3-W, La,-,Ca,Fel-yTiyO3-La-,UCaUFeO3-W, La,-,B4Fel-yGaVO3-W, La,-,Ba,Fel-yTiyO3-, La, -Ba.FeO₃-,, La-,,-Sr,,Al,FelyTiYO3., La,-.-.Sr.Ca,FelyTiyO3-, La₁ , uSr,B4Fel-yTiyO3-w5 La,-,,-Sr,,AlFel-yGavO3-w, La,-x-,,SrxCaFei-yGavO3-W, La-x-,Sr,,BaFel .yGavO3-W, La,-,SrxFel-yTiyO3 -, La,-,Ca,Fel-yTiyO3 w or La, -B,%Fei yTiyO3 w, and more particularly those of formula: LaO.₆Sro.₄Feo.₉Gao. ⁰3-w, Lao.gSro.,Feo.gGao.₁ ⁰3-w, Lao.₅SrO.₅Feo.₉Tio.₁⁰3-w, Lao gSro. Feo₀₉Tio. 1⁰3-w, Lao.₆Sro.₄Feo.₂Co₀.₈03-w or Lao.₉Sro. IFeo.₂Coo.8O₃-w-

According to another particular aspect, the subject of the invention is an organized assembly based on superposed layers, as defined above, characterized in that it comprises: either:

(a) a dense layer (C_{D1}), of thickness E_{D1}, as defined above;

(b) a porous layer (C_{P1}), of thickness E_{P1}, as defined above, adjacent to the said dense layer (C_{D1});

(c) a catalytic layer (C_{C1}), of thickness E_{C1}, as defined above; in which:

Mα and Mβ, actually present in compound (C₁), are respectively identical to Mε and Mη, actually present in compound (C₅);

Mα and Mβ, actually present in compound (C₁), are respectively identical to Mγ and Mδ, actually present in compound (C₃); or:

(a) a dense layer (C_{D1}), of thickness E_{D1}, as defined above;

(b) a porous layer (C_{P1}), of thickness E_{P1}, as defined above, adjacent to the said dense layer (C_{D1});

(c) a catalytic layer (C_{C1}), of thickness E_{C1}, as defined above; and a second porous layer (C_{P2}), of thickness E_{P2}; in which:

Mθ and Mκ, actually present in compound (C₇), are respectively identical to Mε and Mη, actually present in compound (C₅);

Mα and Mβ, actually present in compound (C₁), are respectively identical to Mθ and Mκ, actually present in compound (C₇); and

Mα and Mβ, actually present in compound (C₁), are respectively identical to Mγ

and Mδ, actually present in compound (C₃);

and most particularly an organized assembly based on superposed layers, as defined above, characterized in that it comprises: either:

(a) a dense layer (C_{D1}), of thickness E_{D1}, as defined above;

(b) a porous layer (C_{P1}), of thickness E_{P1}, as defined above, adjacent to the said dense layer (C_{D1});

(c) a catalytic layer (C_{C1}), of thickness E_{C1}, as defined above; in which Mα, Mε and Mγ each represent a lanthanum atom and Mβ, Mη and Mδ each represent an iron atom; or:

(a) a dense layer (C_{D1}), of thickness E_{D1}, as defined above;

(b) a porous layer (C_{P1}), of thickness E_{P1}, as defined above, adjacent to the said dense layer (C_{D1});

(c) a catalytic layer (C_{C1}), of thickness E_{C1}, as defined above; and a second porous layer (Cp₂), of thickness E_{P2}, in which Mθ, Mα, Mε and Mγ each represent a lanthanum atom and Mκ, Mβ, Mη and Mδ each represent an iron atom.

The subject of the invention is also more particularly an organized assembly based on superposed layers of materials of similar chemical nature, as defined above, characterized in that it comprises: either:

(a) a dense layer (C′_{D1}) corresponding to the layer (C_{D1}) defined above and for which the material (A_{D1}) comprises, per 100% of its volume:

(i) at least 95% by volume and at most 100% by volume of a compound (C₁) chosen from compounds of formula:
La₁₋ₓ₋ᵤSrₓAlᵤFe_{1-y}Ti_{y}O_{3-w}, La₁₋ₓ₋ᵤSrₓCaᵤFe_{1-y}Ti_{y}O_{3-w}, La₁₋ₓ₋ᵤSrₓBaᵤFe_{1-y}Ti_{y}O_{3-w}, La₁₋ₓ₋ᵤSrₓAlᵤFe_{1-y}GaᵥO_{3-w}, La₁₋ₓ₋ᵤSrₓCaᵤFe_{1-y}Ga_{y}O_{3-w}, La₁₋ₓ₋ᵤSrₓBaᵤFe_{1-y}Ga_{y}O_{3-w}, La₁₋ₓSrₓFe_{1-y}Ti_{y}O_{3-w}, La₁₋ₓSrₓFe_{1-y}GaᵥO_{3-w}, La₁₋ₓ₋ᵤSrₓCaᵤFeO_{3-w}, La₁₋ᵤCaᵤFeO_{3-w} or La₁₋ₓSrₓFeO_{3-w},
in which:
0<x≦0.5;
0≦u≦0.5;
(x+u)≦0.5;
0≦y≦0.9;
0≦v≦0.9; 0≦(y+v)≦0.9; and
w is such that the structure in question is electrically neutral;

(ii) optionally up to 5% by volume of a compound (C₂), which differs from compound (C₁), as defined above; and

(iii) optionally up to 0.5% by volume of a compound (C₁₋₂) produced from at least one chemical reaction represented by the equation:
xF_{C1}+yF_{C2}→zF_{C1-2},
in which equation F_{C1}, F_{C2} and F_{C1-2}, represent the respective raw formulae of compounds (C₁), (C₂) and (C₁₋₂) and x, y and z represent rational numbers greater than or equal to 0;

(b) a porous layer (C′_{P1}) corresponding to layer (C_{P1}) defined above, for which the material (A_{P1}) comprises, per 100% of its volume:

(i) at least 95% by volume and at most 100% by volume of a compound (C₃) chosen from compounds of formula:
La₁₋ₓSrₓFe_{1-y}GaᵥO_{3-w}, La₁₋ₓSrₓFe_{1-y}Ti_{y}O_{3-w}, La₁₋ₓSrₓFeO_{3-w}, La₁₋ᵤCaᵤFe_{1-y}GaᵥO_{3-w}, La₁₋ᵤCaᵤFe_{1-y}Ti_{y}O_{3-w}, La₁₋ᵤCaᵤFeO_{3-w}, La₁₋ᵤBaᵤFe_{1-y}GaᵥO_{3-w}, La₁₋ᵤBaᵤFe_{1-y}Ti_{y}O_{3-w}, La₁₋ᵤBaᵤFeO_{3-w}, La₁₋ₓ₋ᵤSrₓAlᵤFe_{1-y}Ti_{y}O_{3-w}, La₁₋ₓ₋ᵤSrₓCaᵤFe_{1-y}Ti_{y}O_{3-w}, La₁₋ₓ₋ᵤSrₓBaᵤFe_{1-y}Ti_{y}O_{3-w}, La₁₋ₓ₋ᵤSrₓAlᵤFe_{1-y}GaᵥO_{3-w}, La₁₋ₓ₋ᵤSrₓCaᵤFe_{1-y}GaᵥO_{3-w}, or La₁₋ₓ₋ᵤSrₓBaᵤFe_{1-y}GaᵥO_{3-w},
in which:
0<x≦0.5;
0≦u≦0.5;
(x+u)≦0.5;
0≦y≦0.9;
0≦v≦0.9; 0≦(y+v)≦0.9; and
w is such that the structure in question is electrically neutral;

(ii) optionally up to 5% by volume of a compound (C₄), which is different from compound (C₃), as defined above; and

(iii) optionally up to 0.5% by volume of a compound (C₃₋₄) produced from at least one chemical reaction represented by the equation:
xF_{C3}+yF_{C4}→zF_{C3-4},
in which equation F_{C3}, F_{C4} and F_{C3-4}, represent the respective raw formulae of compounds (C₃), (C₄) and (C₃₋₄) and x, y and z represent rational numbers greater than or equal to 0;

(c) and a catalytic layer (C′_{C1}) corresponding to layer (C_{C1}) defined above, for which the material (A_{C1}) comprises, per 100% of its volume:

(i) at least 95% by volume and at most 100% by volume of a compound (C₅) chosen from compounds of formula:
La₁₋ₓCeₓFe_{1-y-v}Ni_{y}RhᵥO_{3-w}, La₁₋ₓCeₓFe_{1-y}Ni_{y}O_{3-w}, La₁₋ₓSrₓFe_{1-y-v}Ni_{y}RhᵥO_{3-w} and La₁₋ₓSrₓFe_{1-y}Ni_{y}O_{3-w}, in which:
0<x≦0.5;
0≦v≦0.5;
0≦(y+v)≦0.8; and
w is such that the structure in question is electrically neutral;

(ii) optionally up to 5% by volume of a compound (C₆), which is different from compound (C₅), as defined above; and

(iii) optionally up to 0.5% by volume of a compound (C₅₋₆) produced from at least one chemical reaction represented by the equation:
xF_{C5}+yF_{C6}→zF_{C5-6}
in which equation F_{C5}, F_{C6} and F_{C5-6}, represent the respective raw formulae of compounds (C₅), (C₆) and (C₅₋₆) and x, y and z represent rational numbers greater to or equal to 0; or:

(a) a dense layer (C′_{D1}), as defined above;

(b) a porous layer (C′_{P1}), as defined above;

(c) a catalytic layer (C′_{C1}), as defined above;

(d) and a second porous layer (C′_{P2}) corresponding to layer (C_{P2}) defined above, for which the material (A_{P2}) comprises, per 100% of its volume:

(i) at least 95% by volume and at most 100% by volume of a compound (C₇) chosen from compounds of formula:
La₁₋ₓSrₓFe_{1-y}GaᵥO_{3-w}, La₁₋ₓSrₓFe_{1-y}Ti_{y}O_{3-w}, La₁₋ₓSrₓFeO_{3-w}, La₁₋ᵤCaᵤFe_{1-y}GaᵥO_{3-w},
La₁₋ᵤCaᵤFe_{1-y}Ti_{y}O_{3-w}, La₁₋ᵤCaᵤFeO_{3-w}, La₁₋ᵤBaᵤFe_{1-y}GaᵥO_{3-w}La₁₋ᵤBaᵤFe_{1-y}Ti_{y}O_{3-w},
La₁₋ᵤBaᵤFeO_{3-w, La}₁₋ₓ₋ᵤSrₓAlᵤFe_{1-y}Ti_{y}O_{3-w}, L₁₋ₓ₋ᵤSrₓCaᵤFe_{1-y}Ti_{y}O_{3-w},
La₁₋ₓ₋ᵤSrₓBaᵤFe_{1-y}Ti_{y}O_{3-w}, La₁₋ₓ₋ᵤSrₓAlᵤFe_{1-y}GaᵥO_{3-w}, La₁₋ₓ₋ᵤSrₓCaᵤFe_{1-y}GaᵥO_{3-w}, or
La₁₋ₓ₋ᵤSrₓBaᵤFe_{1-y}GaᵥO_{3-w},
in which:
0<x≦0.5;
0≦u≦0.5;
(x+u)≦0.5;
0≦y≦0.9;
0≦v≦0.9; 0≦(y+v)≦0.9; and
w is such that the structure in question is electrically neutral;

(ii) optionally up to 5% by volume of a compound (C₈), which differs from compound (C₇), as defined above; and

(iii) optionally up to 0.5% by volume of a compound (C₇₋₈) produced from at least one chemical reaction represented by the equation:
xF_{C7}+yF_{C5}→zF_{C7-8},
in which equation F_{C7}, F_{C8} and F_{C7-8}, represent the respective raw formulae of compounds (C₇), (C₈) and (C₇₋₈) and x, y and z represent rational numbers greater than or equal to 0.

According to this particular aspect, the organized assembly based on superposed layers of materials of similar chemical nature, as defined above, preferably comprises: either:

(a) a dense layer (C″_{D1}) corresponding to layer (C′_{D1}) defined above and for which the material (A_{D1}) comprises, per 100% of its volume:

(i) at least 95% by volume and at most 100% by volume of a compound (C₁) chosen from compounds of formula La_{0.6}Sr_{0.4}Fe_{0.9}Ga_{0.1}O_{3-w}, or La_{0.5}Sr_{0.5}Fe_{0.9}Ti_{0.1}O_{3-w};

(ii) optionally up to 5% by volume of a compound (C₂), which differs from compound (C₁) as defined above; and

(iii) optionally up to 0.5% by volume of a compound (C₁₋₂) produced from at least one chemical reaction represented by the equation:
xF_{cC1}+yF_{C2}→zF_{C1-2},
in which equation F_{C1}, F_{C2} and F_{C1-2}, represent the respective raw formulae of compounds (C₁), (C₂) and (C₁₋₂) and x, y and z represent rational numbers greater than or equal to 0;

(b) a porous layer (C″_{P1}) corresponding to layer (C′_{P1}) defined above for which the material (A_{P1}) comprises, per 100% of its volume:

(i) at least 95% by volume and at most 100% by volume of a compound (C₃) chosen from compounds of formula:
La_{0.6}Sr_{0.4}Fe_{0.9}Ga_{0.1}O_{3-w}, La_{0.9}Sr_{0.1}Fe_{0.9}Ga_{0.1}O_{3-w}, La_{0.5}Sr_{0.5}Fe_{0.9}Ti_{0.1}O_{3-w},
La_{0.9}Sr_{0.1}Fe_{0.9}Ti_{0.1}O_{3-w}, La_{0.6}Sr_{0.4}Fe_{0.2}Co_{0.8}O_{3-w} or La_{0.9}Sr_{0.1}Fe_{0.2}Co_{0.8}O_{3-w};

(ii) optionally up to 5% by volume of a compound (C₄), which differs from compound (C₃), as defined above; and

(iii) optionally up to 0.5% by volume of a compound (C₃₋₄) produced from at least one chemical reaction represented by the equation:
xF_{C3}+yF_{C4}→zF_{C3-4},
in which equation F_{C3}, F_{C4} and F_{C3-4}, represent the respective raw formulae of compounds (C₃), (C₄) and (C₃₋₄) and x, y and z represent rational numbers greater than or equal to 0;

(c) and a catalytic layer (C″_{C1}) corresponding to layer (C′_{C1}) defined above, for which the material (A_{C1}) comprises, per 100% of its volume:

(i) at least 95% by volume and at most 100% by volume of a compound (C₅) chosen from compounds of formula, La_{0.8}Ce_{0.2}Fe_{0.65}Ni_{0.30}Rh_{0.05}O_{3-w}, La_{0.8}Ce_{0.2}Fe_{0.7}Ni_{0.3}O_{3-w}, La_{0.8}Sr_{0.2}Fe_{0.65}Ni_{0.30}Rh_{0.05}O_{3-w} and La_{0.8}Sr_{0.2}Fe_{0.7}Ni_{0.3}O_{3-w};

(ii) optionally up to 5% by volume of a compound (C₆), which differs from compound (C₅), as defined above; and

(iii) optionally up to 0.5% by volume of a compound (C₅₋₆) produced from at least one chemical reaction represented by the equation:
xF_{C5}+yF_{C6}→zF_{C5-6},
in which equation F_{C5}, F_{C6} and F_{C5-6}, represent the respective raw formulae of compounds (C₅), (C₆) and (C₅₋₆) and x, y and z represent rational numbers of greater than or equal to 0; or:

(a) a dense layer (C″_{D1}), as defined above;

(b) a porous layer (C″_{P1}), as defined above;

(c) a catalytic layer (C″_{C1}), as defined above;

(d) and a second porous layer (C″_{P2}) corresponding to layer (C′_{P2}) defined above, for which the material (A_{P2}) comprises, for 100% of its volume:

(i) at least 95% by volume and at most 100% by volume of a compound (C₇) chosen from compounds of formula, La_{0.6}Sr_{0.4}Fe_{0.9}Ga_{0.1}O_{3-w}, La_{0.9}Sr_{0.1}Fe_{0.9}Ga_{0.1}O_{3-w}, La_{0.5}Sr_{0.5}Fe_{0.9}Ti_{0.1}O_{3-w}, La_{0.9}Sr_{0.1}Fe_{0.9}Ti_{0.1}O_{3-w}, La_{0.6}Sr_{0.4}Fe_{0.2}Co_{0.8}O_{3-w} or La_{0.9}Sr_{0.1}Fe_{0.2}Co_{0.8}O_{3-w}.

(ii) optionally up to 5% by volume of a compound (C₈), which differs from compound (C₇), as defined above; and

(iii) optionally up to 0.5% by volume of a compound (C₇₋₈) produced from at least one chemical reaction represented by the equation:
xF_{C7}+yF_{C5}→zF_{C7-8},
in which equation F_{C7}, F_{C8} and F_{C7-8}, represent the respective raw formulae of compounds (C₇), (C₈) and (C₇₋₈) and x, y and z represent rational numbers greater than or equal to 0.

The subject of the invention is also more particularly an organized assembly based on superposed layers of materials of similar chemical nature, as defined above, characterized in that the materials (A_{D1}), (A_{P1}), (A_{C1}) and, where appropriate, (A_{P2}) and, when they are present, the respective compounds (C₂), (C₄) and (C₈) are chosen independently of one another from magnesium oxide (MgO), the spinel phase (MgAl₂O₄), calcium oxide (CaO), aluminium oxide (A1₂O₃), zirconium oxide (ZrO₂), titanium oxide (TiO₂), strontium-aluminium mixed oxides SrAl₂O₄ or Sr₃Al₂O₆, barium-titanium mixed oxide (BaTiO₃), calcium-titanium mixed oxide (CaTiO₃), La_{0.5}Sr_{0.5}Fe_{0.9}Ti_{0.1}O_{3-ω} or La_{0.6}Sr_{0.4}Fe_{0.9}Ga_{0.1}O_{3-ω}.

According to another particular aspect of the present invention, in the organized assembly based on superposed layers of materials of similar chemical nature, as defined above, one, several or all of the layers from among layers C_{P1}, C_{P2}, and C_{C1} have a discrete porosity gradient, that is to say volume porosity of which varies discretely over the thickness of the layer between a maximum value (on the outside of the layer) and a minimum value (on the inside of the layer, close to the dense membrane).

According to another particular aspect of the present invention, in the organised assembly based on superposed layers of materials of similar chemical nature, as defined above, one, several or all of the layers from among the layers C_{P1}, C_{P2}, and C_{C1} have a continuous porosity gradient, that is to say the volume porosity of which varies continuously over the thickness of the layer between a maximum value (on the outside of the layer) and a minimum value (on the inside of the layer, close to the dense membrane).

Such a porosity gradient is achieved by implementing the process described, for example, in WO 02/46122 which comprises the infiltration of a porous pore-forming substrate by a tape casting suspension.

According to another particular aspect of the present invention, in the organized assembly based on superposed layers of materials of similar chemical nature, as defined above, one, several or all of the dense, porous or catalytic layers have a discrete composition gradient, that is to say the chemical nature of these layers varies discretely over the thickness of the layer or between the layers.

According to another particular aspect of the present invention, in the organized assembly based on superposed layers of materials of similar chemical nature, as defined above, one, several or all of the dense, porous or catalytic layers have a surface concentration gradient of the material of the adjacent layer. Such a gradient may be obtained by implementing the process described, for example, in WO 03/00439 for a planar system.

The organized assembly based on superposed layers of materials of similar chemical nature, forming the subject of the present invention and as defined above, is mainly of planar or tubular form. When it is of tubular form, the CMR thus formed is closed at one of its ends.

The PCMR is prepared by assembling, in the green state, the various layers and the multilayer assembly is either sintered in a single step, called co-sintering, or in several steps.

In general, the tubular PCMR includes a porous support on the outside of which a dense membrane is deposited. The porous support may be formed by extrusion or by isostatic pressing. The dense membrane is deposited on the porous support “in the green state” by various techniques such as, for example, dip coating or spray coating. The assembly (porous support+dense membrane) is co-sintered. The reforming catalyst is then deposited on the outside (on the dense membrane) by various techniques such as, for example, by dip coating or spray coating, and then fired at a temperature below the sintering temperature of the PCMR.

Preferably, a tubular PCMR, which includes a dense layer supported by a porous layer and covered on its outer face with a catalytic layer, is prepared by coextruding the dense layer and the porous layer. The assembly is sintered, the catalytic layer is applied to the external face of the bilayer obtained, and the assembly (catalyst layer+dense membrane/porous support) is fired at a temperature below the sintering temperature. In a second approach, the catalytic layer may be coextruded at the same time as the dense layer and the porous layer. The process is therefore a tri-extrusion process, the system (catalyst/dense membrane/support) being co-sintered.

The coextrusion process is described in French patent application filed on 12 May 2004 and registered under No 04/05124.

In the process as defined above, the sintering temperature of the material is between 800 and 1500° C., preferably between 1000° C. and 1350° C.

According to one particular aspect of the invention, the co-sintering process is carried out while controlling the oxygen partial pressure (pO₂) of the gaseous atmosphere surrounding the reaction mixture. Such a process is described in French patent application filed on 11 July 2003 and registered under No 03/50234.

In the process as defined above, the sintering temperature of the material is between 800 and 1500° C., preferably between 1000° C. and 1350° C.

According to a final aspect, the subject of the invention is a reactor of non-zero internal volume V, intended for the production of syngas by the oxidation of natural gas, characterized in that it comprises either an organized assembly of tubular form, based on superposed layers of materials of similar chemical nature, as defined above, in which the catalytic layer (C_{C1}), capable of promoting the reaction of methanoxidation by gaseous oxygen to carbon monoxide, is located on the external surface of the said assembly of tubular form closed at one of its ends, or a combination of several of these said assemblies of tubular form that are mounted in parallel, which is characterized in that the free volume V_{f} inside the reactor is greater than or equal to 0.25V and is preferably greater than or equal to 0.5V.

According to one particular aspect of this device, in the reactor as defined above, a non-zero fraction of the volume V_{f} contains a steam-reforming catalyst.

The term “steam reforming catalyst” refers to catalysts characterized by the presence of transition metals (Ni, Fe, etc.) and/or of one or more noble metals (Pd, Pt, Rh, Ru, etc.) deposited on oxide or non-oxide ceramic supports, an amount ranging from 0.1 to 60% by weight of the said metal or mixture of metals, the said ceramic supports chosen either from oxide-type materials, such as boron oxide, aluminium oxide, gallium oxide, cerium oxide, silicon oxide, titanium oxide, zirconium oxide, zinc oxide, magnesium oxide or calcium oxide, preferably from magnesium oxide (MgO), calcium oxide (CaO), aluminium oxide (Al₂O₃), zirconium oxide (ZrO₂), titanium oxide (TiO₂) or ceria (CeO₂); aluminium and/or magnesium silicates, such as mullite (2SiO₂.3Al₂O₃) or cordierite (Mg₂Al₄Si₅Oi₈) or such as the spinel phase MgAl₂O₄; the calcium-titanium mixed oxide (CaTiO₃), or CaA1₁₂O₁₉; calcium phosphates and their derivatives, such as hydroxylapatite Ca₁₀(PO₄)₆(OH)₂ or tricalcium phosphate Ca₃(PO₄)₂; or else materials of the perovskite type such as La_{0.5}Sr_{0.5}Fe_{0.9}Ti_{0.1}O_{3-δ}, La_{0.6}Sr_{0.4}Fe_{0.9}Ga_{0.1}O_{3-δ}, La_{0.5}Sr_{0.5}Fe_{0.9}Ti_{0.1}O_{3-δ} or La_{0.6}Sr_{0.4}Fe_{0.9}Ga_{0.1}O_{3-δ}; or else from materials of non-oxide type and preferably from carbides or nitrides, such as silicon carbide (SiC), boron nitride (BN) or aluminium nitride (AlN) or silicon nitride (Si₃N₄), or SiAlONs. The geometry of the reforming catalysts contained between the PCMR tubes may be rods, extrudates or spheres of various sizes.

### DESCRIPTION OF THE FIGURES

FIG. 1A: This figure illustrates one particular architecture of the PCMR, which comprises a porous support layer (C_{P1}) and a catalyst layer (C_{C1}) on either side of a dense layer (C_{D1}). The chemical nature and the crystallographic nature of the layers (C_{P1}, C_{C1}, C_{D1}) illustrated in this figure are defined in the invention.

FIG. 1B: This figure illustrates one particular architecture of the PCMR, which comprises two porous support layers (C_{P1}, C_{P2}) on either side of a dense layer (C_{D1}), and a catalyst layer (C_{C1}) on one of the support layers. The chemical nature and the crystallographic nature of the layers (C_{P1}, C_{P2}, C_{C1}, C_{D1}) illustrated in this figure are defined in the invention.

FIG. 1C: This figure illustrates one particular distribution of the porosity for a PCMR having the architecture described in FIG. 1A. The catalytic layer (C_{C1}) and the support layer (C_{P1}) each have a degree of porosity that is constant over its entire respective thickness. The degree of porosity of the catalytic layer (C_{C1}) and that of the support layer (C_{P1}) may be identical or different. The chemical nature and the crystallographic nature of the layers (C_{P1}, C_{C1}, C_{D1}) illustrated in this figure are defined in the invention.

FIG. 1D: This figure illustrates one particular distribution of the porosity for a PCMR having the architecture described in FIG. 1A. The catalytic layer (C_{C1}) has a constant degree of porosity over its entire thickness, the support layer (C_{P1}) has a degree of porosity varying over its thickness in a discrete manner. The porosity of the support layer (C_{P1}), which takes two levels (C_{P1′} and C_{P1″}) in this figure, may be extended to three or more levels. The degree of porosity of the catalytic layer (C_{C1}) and that of the support layer (C_{P1}) may be identical or different. The chemical nature and the crystallographic nature of the layers (C_{P1}, C_{C1}, C_{D1}) illustrated in this figure are defined in the invention.

FIG. 1E: This figure illustrates one particular distribution of the porosity for a PCMR having the architecture described in FIG. 1A. The catalytic layer (C_{C1}) and the support layer (C_{P1}) each have a degree of porosity varying over its thickness in a discrete manner. The porosities of the support layer (C_{P1}) and catalytic layer (C_{C1}), which take two levels in this figure, (C_{P1 ′} and C_{P1″}) and (C_{C1 ′} and C_{C1″}) respectively, may be extended to three or more levels. The level of porosity of the catalytic layer (C_{C1}) and that of the support layer (C_{P1}) may be identical or different. The chemical nature and the crystallographic nature of the layers (C_{P1}, C_{C1}, C_{D1}) illustrated in this figure are defined in the invention.

FIG. 1F: This figure illustrates one particular distribution of the porosity for a PCMR having the architecture described in FIG. 1A. The catalytic layer has a level of porosity varying over its thickness in a discrete manner (in the figure, two discrete levels of porosity, C_{C1′} and C_{C1″} respectively, are shown). The support layer (C_{P1}) has a level of porosity that varies continuously over its thickness. The chemical nature and the crystallographic nature of the layers (C_{P1}, C_{C1}, C_{D1}) illustrated in this figure are defined in the invention.

FIG. 1G: This figure illustrates one particular distribution of the porosity for a PCMR having the architecture described in FIG. 1A. The catalytic layer (C_{C1}) has a level of porosity that is constant over its thickness. The support layer (C_{P1}) has a level of porosity that varies continuously from a maximum value on its external face to a minimum value at a given depth (C_{P1″}), the level of porosity then remains constant up to the dense layer (C_{P1′}). The chemical nature and the crystallographic nature of the layers (C_{P1}, C_{C1}, C_{D1}) illustrated in this figure are defined in the invention.

FIG. 1H: This figure illustrates one particular distribution of the porosity for a PCMR having the architecture described in FIG. 1A. The catalytic layer (C_{C1}) has a level of porosity that is constant over its thickness. The support layer (C_{P1}) has a level of porosity that is constant between its external face and a given depth (C_{P1′}), the level of porosity then decreasing continuously down to the dense layer (C_{P1 ″}). The chemical nature and the crystallographic nature of the layers (C_{P1}, C_{C1}, C_{D1}) illustrated in this figure are defined in the invention.

FIG. 1I: This figure illustrates the distribution of compounds (C₁) to (C₆) in the various layers of a PCMR having the architecture described in FIG. 1A. The chemical nature and the crystallographic nature of the layers (C_{P1}, C_{C1}, C_{D1}) illustrated in this figure are defined in the invention. The compound (C₁) of the dense layer (C_{D1}) and the compound (C₃) of the porous support (C_{P1}) contain at least two chemical elements in common. Likewise, the compound (C₁) of the dense layer (C_{P1}) and the compound (C₅) of the catalytic layer (C_{C1}) contain at least two chemical elements in common. In contrast, the compound (C₃) of the porous layer (C_{P1}) and the compound (C₅) of the catalytic layer (Ccl) do not necessarily contain two chemical elements in common.

FIG. 1J: This figure illustrates one particular distribution of the cations in a PCMR having the architecture described in FIG. 1A. The support layer (C_{P1}) has a continuous chemical composition gradient at the interface between the dense layer (C_{D1}) and the support layer (C_{P1}). Compound (C₃) of the support layer (C_{P1}) is of the La₁₋ₓSrₓFe₁₋ᵥMb′ᵥO_{3-w} type on its external face for a given cation Mb′. The compound (C₁) of the dense layer (C_{D1}) is of the La₁₋ₓSrₓFe_{1-y}Mb_{y}O_{3-w} type for a given cation Mb. The intermediate compound between the dense layer and the surface of the support layer is of the La₁₋ₓSrₓFe_{1-y-v}Mb_{y}Mb′ᵥO_{3-w} type where y and v vary continuously over the thickness of the zone within this compound. The chemical nature and the crystallographic nature of the layers illustrated in this figure are defined in the invention.

FIG. 1K: This figure illustrates one particular distribution of the cations in a PCMR having the architecture described in FIG. 1A. The dense layer has a continuous chemical composition gradient over its thickness. The compounds (C₁), (C₃) and (C₅) are of the La₁₋ₓSrₓFe_{1-y}Mb_{y}O_{3-w} type, the nature of Mb and the value of y varying according to the layer. The degree of substitution of the lanthanum by strontium, x, varies continuously over the thickness of the dense layer. The value of x at the interface between the dense layer and the support layer may be identical or different on either side of the interface. Likewise, the value of x at the interface between the dense layer and the catalytic layer may be identical or different on either side of the interface. The chemical nature and crystallographic nature of the layers illustrated in this figure are defined in the invention.

FIG. 2A: A micrograph of a PCMR comprising a porous support layer with a discrete porosity gradient (C_{P1} containing C_{P1′} and C_{P1″}) and a porous catalyst layer (C_{C1}) on either side of a thin dense layer (C_{D1}), all of the layers being of perovskite type. The formulations of the compounds of the various layers are presented in the examples. The architecture of this PCMR corresponds to that described in FIG. 1D.

FIG. 2B: A micrograph of a PCMR comprising a porous support layer (C_{P1}), a thin dense layer (C_{D1}) and a catalytic layer (C_{C1}), all of the layers being of perovskite type. The formulations of the compounds of the various layers are presented in the examples. The architecture of this PCMR corresponds to that described in FIG. 1C.

FIG. 3: An X-ray diffraction pattern for polycrystalline specimens of a compound of perovskite type.

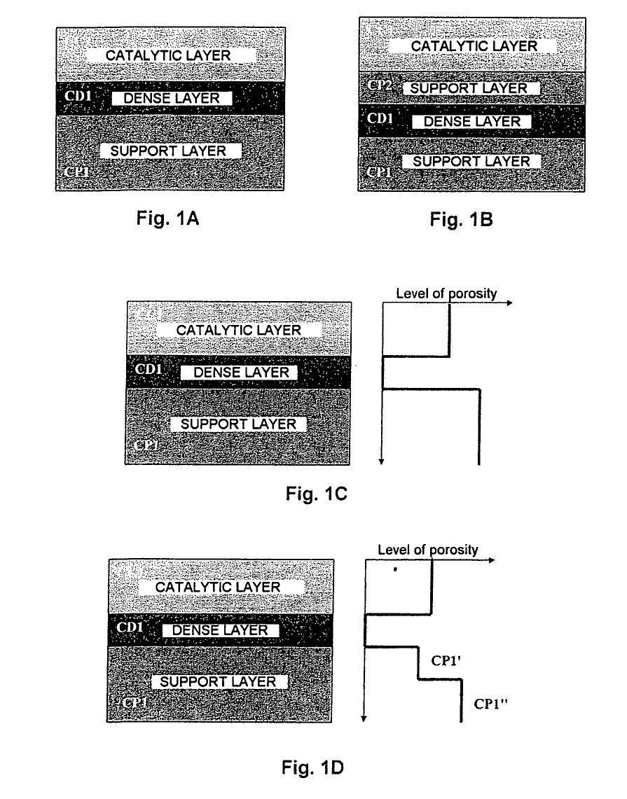

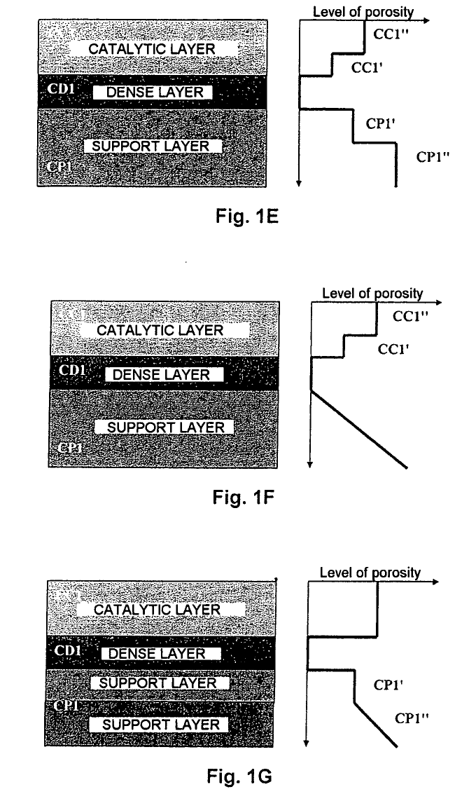

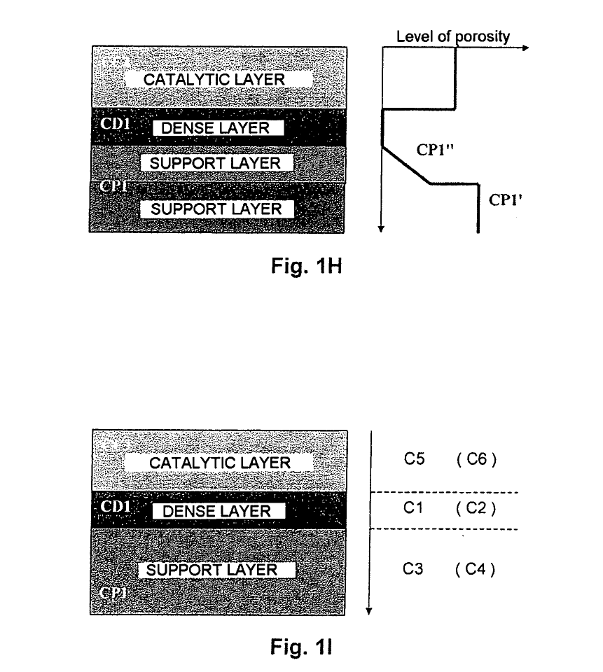

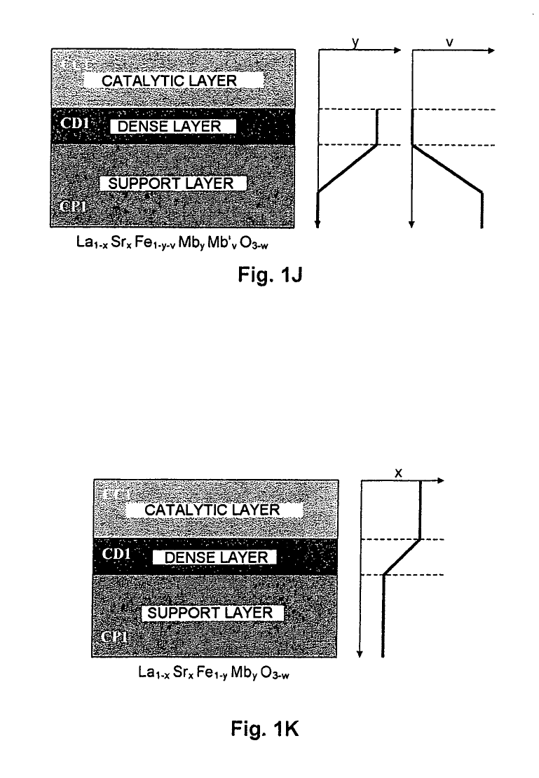

The present invention improves the current state of the art since the use of chemically similar and structurally identical materials allows continuity of the thermomechanical and thermochemical properties over the entire PCMR. The risk of debonding or cracking at the interfaces, or within a layer, is then greatly reduced. Since the expansion coefficients and the shrinkage at sintering of the various materials are similar (FIG. 4), it is possible to sinter all of the layers in a single step (co-sintering), thereby limiting the forming operations (heat treatment) while reducing the manufacturing cost of the PCMR. The following examples illustrate the invention without however limiting it.

### Example 1

Preparation of an Assembly According to the Invention

A—Preparation of La_{0.6}Sr_{0.4}Fe_{0.9}Ga_{0.1}O_{3-δ} (Compnound C₁

Compound (C₁) was prepared by high-temperature reaction of precursors in the solid state.

(1) To synthesize 100 g of compound C₁, the following masses of precursors were weighed after a preliminary heat treatment step so as to remove any residual water or gaseous impurities therefrom:
44.34 g of La₂O₃ (Ampere Industrie; purity>99.99% by weight);
26.79 g of SrCO₃ (Solvay Baris; purity>99% by weight);
32.60 g of Fe₂O₃ (Alfa Aesar; purity>99% by weight);
4.25 g of Ga₂O₃ (Sigma Aldrich; purity>99% by weight).

(2) The mixture was milled in a polyethylene jar provided with a rotating blade, made of the same polymer, in the presence of spherical yttriated zirconia (YSZ) balls, an aqueous or organic solvent and optionally a dispersant. This attrition milling operation resulted in a uniform blend of smaller-diameter powder particles having a relatively spherical shape and a monomodal particle size distribution. After this first milling operation, the mean particle diameter was between 0.3 μm and 2 μm. The contents of the jar were screened using a 200 μm screen to separate the powder from the balls.

(3) The screened material was dried and then calcined over an alumina refractory in a furnace, in air or in a controlled atmosphere. The temperature was then increased up to a hold temperature between 900° C. and 1200° C., and held there for 5 h to 15 h. The rate of temperature rise was typically between 5° C./min and 15° C./min, the rate of fall being governed by the natural cooling of the furnace.

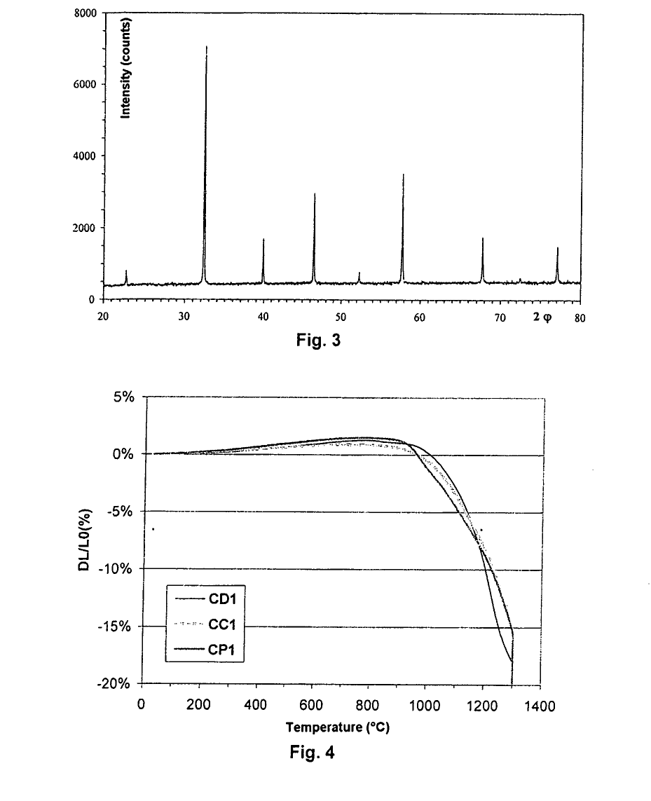

An XRD analysis then enabled the state of reaction of the powders to be verified. If necessary, the powder was milled and/or calcined again using the same protocol until the reaction of the precursors was complete and resulted in the desired perovskite phase (see FIG. 3). The compound La_{0.6}Sr_{0.4}Fe_{0.9}Ga_{0.1}O_{3-δ} was thus obtained.

B—Preparation of a Material A_{D1} (La_{0.6}Sr_{0.4}Fe_{0.9}Ga_{0.1}O_{3-δ} by volume+2% MgO by Volume)

The material A_{D1} was obtained by mixing 98% by volume of compound C₁ prepared in the preceding section and 2% by volume of commercial magnesium oxide (MgO).

C—Preparation of La_{0.5}Sr_{0.5}Fe_{0.9}Ti_{0.1}O_{3-δ} (Compound C₃)

Compound (C₃) was prepared by high-temperature reaction of precursors in the solid state.

(1) To synthesize 100 g of compound C₃, the following masses of precursors were weighed after a preliminary heat treatment step so as to remove any residual water or gaseous impurities therefrom:
38.37 g of La₂O₃ (Ampere Industrie; purity>99.99% by weight);
34.77 g of SrCO₃ (Solvay Baris; purity>99% by weight);
33.85 g of Fe₂O₃ (Alfa Aesar; purity>99% by weight);
1.88 g of TiO₂ (Sigma Aldrich; purity>99% by weight).

(2) The mixture was milled in a polyethylene jar provided with a rotating blade, made of the same polymer, in the presence of spherical yttriated zirconia (YSZ) balls, an aqueous or organic solvent and optionally a dispersant. This attrition milling operation resulted in a uniform blend of smaller-diameter powder particles having a relatively spherical shape and a monomodal particle size distribution. After this first milling operation, the mean particle diameter was between 0.3 μm and 2 μm. The contents of the jar were screened using a 200 μm screen to separate the powder from the balls.

(3) The screened material was dried and then calcined over an alumina refractory in a furnace, in air or in a controlled atmosphere. The temperature was then increased up to a hold temperature between 900° C. and 1200° C., and held there for 5 h to 15 h. The rate of temperature rise was typically between 5° C./min and 15° C./min, the rate of fall being governed by the natural cooling of the furnace.

An XRD analysis then enabled the state of reaction of the powders to be verified. If necessary, the powder was milled and/or calcined again using the same protocol until the reaction of the precursors was complete and resulted in the desired perovskite phase (see FIG. 3). The compound La_{0.5}Sr_{0.5}Fe_{0.9}Ti_{0.1}O_{3-δ} was thus obtained.

D—Preparation of La_{0.8}Ce_{0.2}Fe_{0.7}Ni_{0.3}O_{3-δ} (Compound C₅ .

The compound (C₅) was prepared using a protocol identical to that indicated in section A above, but starting from the following precursor masses:
53.62 g of La₂O₃ (Ampere Industrie; purity>99.99% by weight);
14.16 g of CeO₂ (Alfa Aesar; purity>99.9% by weight);
23.00 g of Fe₂O₃ (Alfa Aesar; purity>99% by weight);
14.65 g of NiCO₃ (Alfa Aesar; purity>99% by weight).

An XRD analysis enabled the reaction state of the powders to be verified. The powders were possibly milled and/or calcined again using the same protocol until the reaction of the precursors was complete and resulted in the desired perovskite phase. The compound La_{0.8}Ce_{0.2}Fe_{0.7}Ni_{0.3}O_{3-δ} was thus obtained.

D′—Preparation of La_{0.6}Sr_{0.4} Fe_{0.7}Ni_{0.3}O_{3-δ} (Compound C′₅)

The compound (C′₅) was prepared using a protocol identical to that indicated in the previous section A, but starting with the following precursor masses:
67.41 g of La₂O₃ (Ampere Industrie; purity>99.99% by weight);
40.73 g of SrCO₃ (Solvay Baris; purity>99.9% by weight);
38.55 g of Fe₂O₃ (Alfa Aesar; purity>99% by weight);
24.56 g of NiCO₃ (Alfa Aesar; purity>99% by weight).

An XRD analysis enabled the state of reaction of the powders to be verified. The powders were possibly milled and/or calcined again, using the same protocol, until the reaction of the precursors was complete and resulted in the desired perovskite phase. Thus the compound La_{0.6}Sr_{0.4}Fe_{0.7}Ni_{0.3}O_{3-δ} was obtained.

E—Preparation of a Dense Layer C_{P1}

The dense layer C_{D1} was produced from the material A_{D1} prepared in section B above and formed by a conventional tape casting process.

F—Preparation of a Material A_{P1}(95% La_{0.5}Sr_{0.5}Fe_{0.9}Ti_{0.1}O_{3-δ} by Volume+5% MgO by Volume)

The material A_{P1} was obtained by blending 95% by volume of compound C₃ prepared in section C above with 5% by volume of commercial magnesium oxide (MgO).

G—Preparation of a Porous Layer C_{P1}

The porous layer C_{P1} was produced from the material A_{P1} prepared in section F above and formed by a conventional tape casting process similar to that of section E. The pores in the layer were obtained after sintering by addition of a pore-forming agent to the liquid suspension of the ceramic material. The term “pore-forming agent” is understood to mean an organic compound, of controlled size and controlled morphology, capable of degrading entirely by a low-temperature heat treatment, typically at 600° C. The final porosity is controlled by choosing the shape, the size and the content of the pore former introduced into the liquid suspension of the ceramic material.

H—Preparation of a Porous Layer C_{p′1+p″1}

The porous layer C_{1′1+p″1}, with a continuous and/or discontinuous controlled-porosity gradient with various porosities P1′ and P1″ was produced from the material Aₚ₁ prepared in section F above,

(i) by infiltration of a porous pore-forming substrate of controlled thickness by a liquid suspension of the ceramic material Aₚ₁ in the case of a continuous porosity gradient or

(ii) by the stacking of tapes of materials A_{P1 ′} and A_{P1″} of various porosities P1′ and P1″ having different contents of pore-forming agents (for example 30% and 40% by volume).

The porous pore-forming substrate was itself produced by tape casting a liquid suspension of pore former. The final porosity was controlled by the choice, the shape, the size and the content of the pore former introduced into the liquid suspension of the ceramic material.

The discontinuous and/or continuous porosity gradients were obtained after the sintering.

I—Preparation of a Porous Layer C_{C1}

The porous layer C_{C1} was produced from the material C₅ or C′₅, prepared respectively in sections D and D′ above, and formed by a conventional tape casting process similar to that of section E. The pores in the layer after sintering were produced by the addition of a pore-forming agent to the liquid suspension of the ceramic material.

J—Preparation of a Multilayer (C_{C1}/C_{D1}/C_{P1}) Planar PCMR with a Discrete Porosity Gradient (P1 and P1′) in the Porous Support C_{P1}

The multilayer PCMR of planar shape was produced by cutting tapes of the various layers prepared as described in the preceding sections, the cut tapes preferably being of identical size. The stack then underwent thermocompression bonding with the desired architecture.

The thermocompression bonding was carried out at pressures close to 50 MPa and temperatures above the glass transition temperatures of the polymers used for the mechanical integrity of the tape, typically 80° C. After the thermocompression bonding, the multilayer had to be coherent and not cracked.

The multilayer obtained underwent a first heat treatment at 600° C. with a slow temperature rise, typically between 0.1 and 2° C./min, in air or in nitrogen.

After this step of removing the binder, the multilayer (C_{C1}/C_{D1}/C_{P1}) was co-sintered at 1300° C. for 30 minutes in nitrogen.

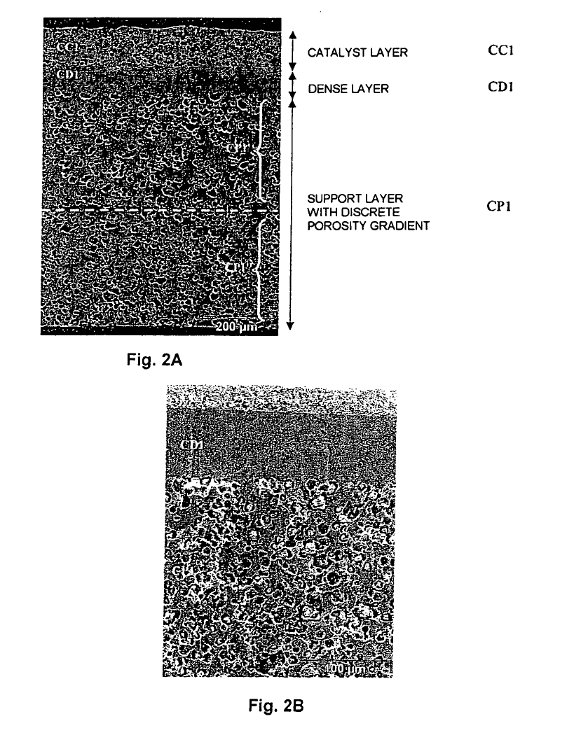

FIG. 2A shows a PCMR consisting, respectively, of:
a catalytic layer Cci prepared in section I and consisting of the material C₅ (La_{0.8}Ce_{0.2}Fe_{0.7}Ni_{0.3}O_{3-δ}, prepared in section D);
a dense layer C_{D1} consisting of the material A_{D1} prepared in section B;
a porous layer C_{P1} consisting of the material A_{P1} prepared in section H and having a discrete porosity gradient P1′ and P1″ , as shown in the figure by the zone Cp1′ and CP1″.
   K—Preparation of a Multilaver (C_{C1}/C_{D1}/C_{P1}) PCMR With a Single Level of Porosity in the Porous Support C_{P1}

The procedure was as in the preceding section, with:
a catalytic layer C_{C1} prepared in section I and consisting of the material C′₅ (La_{0.6}Sr_{0.4}Fe_{0.7}Ni_{0.3}O_{3-δ} prepared in section D′);
a dense layer C_{D1} consisting of the material A_{D1} prepared in section B; and

a porous layer C_{P1} consisting of the material A_{P1} prepared in section G and having a single porosity P1.

The multilayer shown in FIG. 2B was obtained.

L—Production of a Planar PCMR of Complex Architecture

The thermocompression bonding and sintering protocol carried out on tapes of various types allowed a wide range of possible architectures of the PCMR to be obtained. A discrete porosity gradient within the porous layer could be achieved by stacking two tapes produced from two liquid suspensions having different contents of pore former introduced. The thicknesses of the various layers could be adjusted either by varying the thickness of the tape during the tape casting operation, or by stacking various tapes of the same type. The distribution of the layers in the PCMR was chosen during superposition of the tapes before the thermocompression bonding. Finally, the continuous composition gradient could be obtained during sintering by the chemical elements migrating from one layer to another. In the latter case, the compounds were chosen for their ability to enter into solid solution and the sintering heat treatment was adjusted in order to allow the elements to diffuse.

M—Production of a PCMR of Tubular Shape

The porous support and the dense layer were formed by simultaneously extruding the two layers, or by coextrusion. The tubular bilayer was then sintered, and the catalytic layer was then deposited on the tube by dip coating before a further heat treatment, after which the catalytic layer had the specified porosity.

The present invention improves the current state of the art since the use of chemically similar and structurally identical materials allows continuity of the thermomechanical and thermochemical properties over the entire PCMR. The risk of debonding or cracking at the interfaces, or within a layer, is then greatly reduced. Since the expansion coefficients and the shrinkage at sintering of the various materials are similar (FIG. 4), it is possible to sinter all of the layers in a single step (co-sintering), thereby limiting the forming operations (heat treatment) while reducing the manufacturing cost of the PCMR.

1-21. (canceled)

22. An organized assembly based on superposed layers of materials of similar chemical nature, wherein it comprises: either:
a) a dense layer (C_{D1}), with a thickness E_{D1}, the porosity of which does not exceed 5% by volume, the said dense layer (C_{D1}) consisting of a material (A_{D1}) comprising, for 100% of its volume:
i) at least 75% by volume and at most 100% by volume of a compound (C₁) chosen from doped ceramic oxides which, at the use temperature, are in the form of a crystal lattice with oxide ion vacancies of perovskite phase, of formula (I):
Mα₁₋ₓ₋ᵤ Mα′ₓ Mα″ᵤ Mβ_{1-y-v} Mβ′_{y} Mβ″ᵥ O_{3-w} (I)
in which:
Mα represents an atom chosen from scandium, yttrium or from the family of lanthanides, actinides or alkaline-earth metals;
Mα′, which differs from Mα, represents an atom chosen from scandium, yttrium or from the families of lanthanides, actinides or alkaline-earth metals;
Mα″, which differs from Mα and Mα′, represents an atom chosen from aluminium (Al), gallium (Ga), indium (In), thallium (TI) or from the family of alkaline-earth metals;
Mβ represents an atom chosen from transition metals;
Mβ′, which is different from Mβ, represents an atom chosen from transition metals, aluminium (Al), indium (In), gallium (Ga), germanium (Ge), antimony (Sb), bismuth (Bi), tin (Sn), lead (Pb) or titanium (Ti);
Mβ″, which differs from Mβ and Mβ′, represents an atom chosen from transition metals, metals of the alkaline-earth family, aluminium (Al), indium (In), gallium (Ga), germanium (Ge), antimony (Sb), bismuth (Bi), tin (Sn), lead (Pb) or titanium (Ti);
0<x≦0.5;
0≦u≦0.5;
(x+u)≦0.5;
0≦y≦0.9;
0≦v≦0.9; 0≦(y+v)≦0.9; and
w is such that the structure in question is electrically neutral;
ii) optionally up to 25% by volume of a compound (C₂), which differs from compound (C₁), chosen either from oxide-type materials such as boron oxide, aluminium oxide, gallium oxide, cerium oxide, silicon oxide, titanium oxide, zirconium oxide, zinc oxide, magnesium oxide or calcium oxide, preferably from magnesium oxide (MgO), calcium oxide (CaO), aluminium oxide (Al₂O₃), zirconium oxide (ZrO₂), titanium oxide (TiO₂) or ceria (CeO₂); strontium-aluminium mixed oxides SrAl₂O₄ or Sr₃Al₂O₆; barium-titanium mixed oxide (BaTiO₃); calcium-titanium mixed oxide (CaTiO₃); aluminium and/or magnesium silicates, such as mullite (2SiO₂.3Al₂O₃), cordierite (Mg₂Al₄Si₅Oi₈) or the spinel phase MgAl₂O₄; calcium-titanium mixed oxide (CaTiO₃); calcium phosphates and their derivatives, such as hydroxylapatite Ca,₁₀(PO₄)₆(OH)₂ or tricalcium phosphate Ca₃(PO₄)₂; or else materials of the perovskite type, such as La_{0.5}Sr_{0.5}Fe_{0.9}Ti_{0.1}O_{3-δ}, La_{0.6}Sr_{0.4}Fe_{0.9}Ga_{0.1}O₃₋₆₇, La_{0.5}Sr_{0.5}Fe_{0.9}Ga_{0.1}O_{3-δ} or La_{0.6}Sr_{0.4}Fe_{0.9}Ti_{0.1}O_{3-δ}, or else from materials of the non-oxide type, preferably chosen from carbides or nitrides such as silicon carbide (SiC), boron nitride (BN), aluminium nitride (AIN) or silicon nitride (Si₃N₄), “sialons” (SiAION), or from nickel (Ni), platinum (Pt), palladium (Pd) or rhodium (Rh); metal alloys or mixtures of these various types of material; and
iii) optionally up to 2.5% by volume of a compound (C₁₋₂) produced from at least one chemical reaction represented by the equation:
xF_{C1}+yF_{C2}→zF_{C1-2},
in which equation F_{C1}, F_{C2}, and F_{C1-2} represent the respective raw formulae of compounds (C₁), (C₂), and (C₁₋₂), and x, y, and z represent rational numbers greater than or equal to 0;
b) a porous layer (C_{P1}), with a thickness of E_{P1}, the volume porosity of which is between 20% and 80%, adjacent to the said dense layer (CD₁), the said porous layer (C_{P1}) consisting of a material (A_{P1}) comprising, per 100% of its volume:
i) at least 75% by volume and at most 100% by volume of a compound (C₃) chosen from doped ceramic oxides which, at the use temperature, are in the form of a crystal lattice having oxide ion vacancies of perovskite phase, of formula (II):
Mγ₁₋ₓ₋ᵤ Mγ′ₓ Mγ″ᵤ Mδ_{1-y-v} Mδ′_{y} Mδ″ᵥO_{3-w} (II)
in which:
Mγ represents an atom chosen from scandium, yttrium or from families of lanthanides, actinides or alkaline-earth metals;
Mγ′, which differs from Mγ, represents an atom chosen from scandium, yttrium or from families of lanthanides, actinides or alkaline-earth metals;
Mγ″, which differs from Mγ and Mγ′, represents an atom chosen from aluminium (Al), gallium (Ga), indium (In), thallium (TI) or from the family of alkaline-earth metals;
Mδ represents an atom chosen from transition metals;
Mδ′, which differs from Mδ, represents an atom chosen from transition metals, aluminium (Al), indium (In), gallium (Ga), germanium (Ge), antimony (Sb), bismuth (Bi), tin (Sn), lead (Pb) or titanium (Ti);
Mδ″, which differs from Mδ and Mδ′, represents an atom chosen from transition metals, metals of the alkaline-earth family, aluminium (Al), indium (In), gallium (Ga), germanium (Ge), antimony (Sb), bismuth (Bi), tin (Sn), lead (Pb) or titanium (Ti);
0<x ≦0.5;
0≦u≦0.5;
(x+u)≦0.5;
0≦y≦0.9;
0≦v≦0.9;
0(y+v)≦0.9; and
w is such that the structure in question is electrically neutral;
ii) optionally up to 25% by volume of a compound (C₄), which differs from compound (C₃), chosen either from oxide-type materials such as boron oxide, aluminium oxide, gallium oxide, cerium oxide, silicon oxide, titanium oxide, zirconium oxide, zinc oxide, magnesium oxide or calcium oxide, preferably from magnesium oxide (MgO), calcium oxide (CaO), aluminium oxide (Al₂O₃), zirconium oxide (ZrO₂), titanium oxide (TiO₂) or ceria (CeO₂); strontium-aluminium mixed oxides SrAl₂O₄ or Sr₃Al₂O₆; barium-titanium mixed oxide (BaTiO₃); calcium-titanium mixed oxide (CaTiO₃); aluminium and/or magnesium silicates, such as mullite (2SiO₂.3Al₂O₃), cordierite (Mg₂Al₄Si₅O₁₈) or the spinel phase MgAl₂O₄; calcium-titanium mixed oxide (CaTiO₃); calcium phosphates and their derivatives, such as hydroxylapatite Ca₁₀(PO₄)₆(OH)₂ or tricalcium phosphate Ca₃(PO₄)₂; or else materials of the perovskite type, such as La_{0.5}Sr_{0.5}Fe_{0.9}Ti_{0.1}O₃₋₆₇, La_{0.6}Sr_{0.4}Fe_{0.9}Ga_{0.1}O_{3-δ}, La_{0.5}Sr_{0.5}Fe_{0.9}Ga_{0.1}O_{3-δ} or La_{0.6}Sr_{0.4}Fe_{0.9}Ti_{0.1}O_{3-δ}, or else from materials of the non-oxide type, preferably chosen from carbides or nitrides such as silicon carbide (SiC), boron nitride (BN), aluminium nitride (AIN) or silicon nitride (Si₃N₄), “sialons” (SiAION), or from nickel (Ni), platinum (Pt), palladium (Pd) or rhodium (Rh); metal alloys or mixtures of these various types of material; and
iii) optionally, up to 2.5% by volume of a compound (C₃₋₄) produced from at least one chemical reaction represented by the equation:
xF_{C3}+yF_{C4}→zF_{C3-4,}
in which equation F_{C3}, F_{C4}, and F_{C3-4} represent the respective raw formulae of compounds (C₃), (C₄), and (C₃₋₄), and x, y, and z represent rational numbers greater than or equal to 0; and
c) a catalytic layer (C_{C1}), capable of promoting the reaction of partial oxidation of methane by gaseous oxygen to carbon monoxide and hydrogen, the said catalytic layer (C_{C1}), of thickness E_{C1}, having a volume porosity of between 20% and 80%, being adjacent to the said dense layer (C_{D1}) and consisting of a material (A_{C1}) comprising, per 100% of its volume:
i) at least 10% by volume and at most 100% by volume of a compound (C₅) chosen from doped ceramic oxides which, at the use temperature, are in the form of a crystal lattice having oxide ion vacancies of perovskite phase, of formula (III):
Mε₁₋ₓ₋ᵤ Mε′ₓ Mε″ᵤ Mη_{1-y-v} Mη′_{y} Mη″ᵥO_{3-w} (III)
in which:
Mε represents an atom chosen from scandium, yttrium or from families of lanthanides, actinides or alkaline-earth metals;
Mε′, which differs from Mε, represents an atom chosen from scandium, yttrium or from families of lanthanides, actinides or alkaline-earth metals;
Mε″, which differs from Mε and from Mε′, represents an atom chosen from aluminium (Al), gallium (Ga), indium (In), thallium (TI) or from the family of alkaline-earth metals;
Mη represents an atom chosen from transition metals;
Mη′, which differs from Mη, represents an atom chosen from transition metals, aluminium (Al), indium (In), gallium (Ga), germanium (Ge), antimony (Sb), bismuth (Bi), tin (Sn), lead (Pb) or titanium (Ti);
Mη″, which differs from Mη and from Mη″, represents an atom chosen from transition metals, metals from the alkaline-earth family, aluminium (Al), indium (In), gallium (Ga), germanium (Ge), antimony (Sb), bismuth (Bi), tin (Sn), lead (Pb) or titanium (Ti);
0<x≦0.5;
0≦u≦0.5;
(x+u)≦0.5;
0≦y≦0.9;
0≦v≦0.9;
0≦(y+v)≦0.9; and
w is such that the structure in question is electrically neutral;
ii) optionally up to 90% by volume of a compound (C₆), which differs from compound (C₅), chosen from nickel (Ni), iron (Fe), cobalt (Co), palladium (Pd), platinum (Pt), rhodium (Rh), ruthenium (Ru) or a mixture of these metals, optionally deposited on an oxide or non-oxide ceramic support, in an amount from 0.1% to 60% by weight of the said metal or of the mixture of metals, the said ceramic supports being chosen: either from oxide-type materials such as boron oxide, aluminium oxide, cerium oxide, silicon oxide, titanium oxide, zirconium oxide, zinc oxide, magnesium oxide or calcium oxide, preferably from magnesium oxide (MgO), calcium oxide (CaO), aluminium oxide (Al₂O₃), zirconium oxide (ZrO₂), titanium oxide (TiO₂) or ceria (CeO₂); aluminium and/or magnesium silicates, such as mullite (2SiO₂.3Al₂O₃), cordierite (Mg₂Al₄Si₅O₁₈) or the spinel phase MgAl₂O₄; calcium-titanium mixed oxide (CaTiO₃) or calcium-aluminium mixed oxide (CaAl₁₂O₁₉); calcium phosphates and their derivatives, such as hydroxylapatite Ca₁₀(PO₄)₆(OH)₂ or tricalcium phosphate Ca₃(PO₄)₂; or else materials of the perovskite type, such as La_{0.5}Sr_{0.5}Fe_{0.9}Ti_{0.1}O₃₋₆₇ , La_{0.6}Sr_{0.4}Fe_{0.9}Ga_{0.1}O_{3-δ}, La_{0.5}Sr_{0.5}Fe_{0.9}Ga_{0.1}O₃₋₆₇ or La_{0.6}Sr_{0.4}Fe_{0.9}Ti_{0.1}O₃₋₆₇ , or else from materials of the non-oxide type, preferably chosen from carbides or nitrides such as silicon carbide (SiC), boron nitride (BN), aluminium nitride (AIN) or silicon nitride (Si₃N₄), sialons (SlAION);
iii) optionally up to 2.5% by volume of a compound (C₅₋₆) produced from at least one chemical reaction represented by the equation:
xF_{C5}+yF_{C6}→zF_{C5-6},
in which equation F_{C5}, F_{C6}, and F_{C5-6}, represent the respective raw formulae of compounds (C₅), (C₆), and (C₅₋₆), and x, y, and z represent rational numbers greater than or equal to 0; so as to constitute an assembly E₁ consisting of three successive layers {(C_{C1}), (C_{D1}), (C_{P1})}, in which:
at least two of the chemical elements Mα, Mα′, Mα″, Mβ, Mβ′ or Mβ″ actually present in compound (C₁), are identical to two of the chemical elements Mε, Mε′, Mε″, Mη, Mη′ or Mη″ actually present in compound (C₅);
at least one of the chemical elements, Mα, Mα′, Mα″, Mβ, Mβ′ or Mβ″, actually present in compound (C₁), is different from one of the chemical elements Mε, Mε′, Mε″, Mη, Mη′ or Mη″ actually present in compound (C₅);
at least two of the chemical elements Mα, Mα′, Mα″, Mβ, Mβ′ or Mβ″ actually present in compound (C₁) are identical to two of the chemical elements Mγ, Mγ′, Mγ″, Mδ, Mδ′ or Mδ″ actually present in compound (C₃); and
at least one of the chemical elements Mα, Mα′, Mα″, Mβ, Mβ′ or Mβ″, actually present in compound (C₁) is different from one of the chemical elements Mγ, Mγ′, Mγ″, Mδ, Mδ′ or Mδ″ actually present in compound (C₃); or:
a) a dense layer (C_{D1}), of thickness E_{D1}, as defined above;
b) a porous layer (C_{P1}), of thickness E_{P1}, as defined above, adjacent to the said dense layer (C_{D1});
c) a catalytic layer (C_{C1}), of thickness E_{C1} as defined above; and
d) a second porous layer (CP₂), of thickness E_{P2}, the volume porosity of which is between 20% and 80%, inserted between the said catalytic layer (C_{C1}) and the said dense layer (C_{D1}), the said porous layer (C_{P2}) consisting of a material (A_{P2}) comprising, per 100% of its volume:
i) at least 75% by volume and at most 100% by volume of a compound (C₇) chosen from doped ceramic oxides which, at the use temperature, are in the form of a crystal lattice having oxide ion vacancies of perovskite phase, of formula (IV):
Mθ₁₋ₓ₋ᵤ Mθ′ₓ Mθ″ᵤ Mκ_{1-y-v} Mκ′_{y} Mκ″ᵥO_{3-w} (IV)
in which:
Mθ represents an atom chosen from scandium, yttrium or from families of lanthanides, actinides or alkaline-earth metals;
Mθ′, which differs from Mθ, represents an atom chosen from scandium, yttrium or from families of lanthanides, actinides or alkaline-earth metals;
Mθ″, which differs from Mθ and from Mθ′, represents an atom chosen from aluminium (Al), gallium (Ga), indium (In), thallium (TI) or from the family of alkaline-earth metals;
Mκ represents an atom chosen from transition metals;
Mκ′, which differs from Mκ, represents an atom chosen from transition metals, aluminium (Al), indium (In), gallium (Ga), germanium (Ge), antimony (Sb), bismuth (Bi), tin (Sn), lead (Pb) or titanium (Ti);
Mκ″, which differs from Mκ and from Mκ′, represents an atom chosen from transition metals, metals from the alkaline-earth family, aluminium (Al), indium (In), gallium (Ga), germanium (Ge), antimony (Sb), bismuth (Bi), tin (Sn), lead (Pb) or titanium (Ti);
0<x≦0.5;
0≦u≦0.5;
(x+u)≦0.5;
0≦y≦0.9;
0≦v≦0.9;
0≦(y+v)≦0.9; and
w is such that the structure in question is electrically neutral;
ii) optionally up to 25% by volume of a compound (C₈), which differs from compound (C₇), chosen either from oxide-type materials such as boron oxide, aluminium oxide, gallium oxide, cerium oxide, silicon oxide, titanium oxide, zirconium oxide, zinc oxide, magnesium oxide or calcium oxide, preferably from magnesium oxide (MgO), calcium oxide (CaO), aluminium oxide (Al₂O₃), zirconium oxide (ZrO₂), titanium oxide (TiO₂) or ceria (CeO₂); strontium-aluminium mixed oxides SrAl₂O₄ or Sr₃Al₂O₆; barium-titanium mixed oxide (BaTiO₃); calcium-titanium mixed oxide (CaTiO₃); aluminium and/or magnesium silicates, such as mullite (2SiO₂.3Al₂O₃), cordierite (Mg₂Al₄Si₅O₁₈) or the spinel phase MgAl₂O₄; calcium-titanium mixed oxide (CaTiO₃); calcium phosphates and their derivatives, such as hydroxylapatite Ca₁₀(PO₄)₆(OH)₂ or tricalcium phosphate Ca₃(PO₄)₂; or else materials of the perovskite type, such as La_{0.5}Sr_{0.5}Fe_{0.9}Ti_{0.1}O₃₋₆₇ , La_{0.6}Sr_{0.4}Fe_{0.9}Ga_{0.1}O_{3-δ}, La_{0.5}Sr_{0.5}Fe_{0.9}Ga_{1.0}O_{3-δ} or La_{0.6}Sr_{0.4}Fe_{0.9}Ti_{0.1}O₃₋₆₇ , or else from materials of the non-oxide type, preferably chosen from carbides or nitrides such as silicon carbide (SiC), boron nitride (BN), aluminium nitride (AIN) or silicon nitride (Si₃N₄), “sialons” (SiAION), or from nickel (Ni), platinum (Pt), palladium (Pd) or rhodium (Rh); metal alloys or mixtures of these various types of material; and
iii) optionally up to 2.5% by volume of a compound (C₇₋₈) produced from at least one chemical reaction represented by the equation:
xF_{C7}+yF_{C8}zF_{C7-8},
in which equation F_{C7}, F_{C8}, and F_{C7-8}, represent the respective raw formulae of compounds (C₇), (C₈), and (C₇₋₈), and x, y, and z represent rational numbers greater than or equal to 0, so as to constitute an assembly E₂ consisting of four successive layers {(C_{C1}), (C_{P2}), (C_{D1}), (C_{P1})} in which:
at least two of the chemical elements Mθ, Mθ′, Mθ″, Mκ, Mκ′ or Mκ″ actually present in compound (C₇) are identical to two of the chemical elements Mε, Mε′, Mε″, Mη, Mη′ or Mη″ actually present in compound (C₅);
at least one of the chemical elements Mθ, Mθ′, Mθ″, Mκ, Mκ′ or Mκ″, actually present in the compound (C₇) is different from one of the chemical elements Mε, Mε′, Mε″, Mη, Mη′ or Mη″ actually present in compound (C₅);
at least two of the chemical elements Mα, Mα′, Mα″, Mβ, Mβ′ or Mβ″ actually present in compound (C₁) are identical to two of the chemical elements Mθ, Mθ′, Mθ″, Mκ, Mκ′ or Mκ″ actually present in compound (C₇);
at least one of the chemical elements Mα, Mα′, Mα″, Mβ, Mβ′ or Mβ″ actually present in compound (C₁) is different from one of the chemical elements Mθ, Mθ′, Mθ″, Mκ, Mκ′ or Mκ″ actually present in compound (C₇);
at least two of the chemical elements Mα, Mα′, Mα″, Mβ, Mβ′ or Mβ″ actually present in compound (C₁) are identical to two of the chemical elements Mγ, Mγ′, Mγ″, Mδ, Mδ′ or Mδ″ actually present in compound (C₃); and
at least one of the chemical elements Mα, Mα′, Mα″, Mβ, Mβ′ or Mβ″ actually present in compound (C₁) is different from one of the chemical elements Mγ, Mγ′, Mγ″, Mδ, Mδ′ or Mδ″ actually present in compound (C₃).

23. The organized assembly based on superposed layers of materials of similar chemical nature, as defined in claim 22, in which the volume proportions of compounds (C₁₋₂), (C₃₋₄), (C₅₋₆), and (C₇₋₈) optionally present in the materials (A_{D1}), (A_{P1}), (A_{C1}), and (A_{P2}), respectively, tend towards 0.

24. The organized assembly based on superposed layers of materials of similar chemical nature, as defined in claim 22, in which the volume proportions of compounds (C₂), (C₄), (C₆), and (C₈) optionally present in the materials (A_{D1}), (A_{P1}), (A_{C1}), and (A_{P2}), are greater than or equal to 0.1% and less than or equal to 10%.

25. The organized assembly based on superposed layers of materials of similar chemical nature, as defined in claim 22, in which compound (C₁) is chosen:
a) from compounds of formula (Ia):
La₁₋ₓ₋ᵤMα′ₓMα″ᵤMβ_{1-y-v}Mβ′_{y}Mβ″ᵥO_{3-w} (Ia),
corresponding to formula (I), in which Mα represents a lanthanum atom;
b) from compounds of formula (Ib):
Mα₁₋ₓ₋ᵤSrₓMα″ᵤMβ_{1-y-v}Mβ″ᵥO_{3-w} (Ib),
corresponding to formula (II), in which Mα′ represents a strontium atom;
c) from compounds of formula (Ic):
Mα₁₋ₓ₋ᵤMα′ₓMα″ᵤFe_{q-y-v}Mβ′_{y}Mβ″ᵥO_{3-w} (Ic),
corresponding to formula (I), in which Mβ represents an iron atom;
d) from compounds of formula (Id):
Mα₁₋ₓ₋ᵤMα′ₓMα″ᵤTi_{1-y-v}M_{β′}_{y}Mβ″ᵥO_{3-w} (Id),
corresponding to formula (I), in which Mβ represents a titanium atom; or
e) from compounds of formula (Ie):
Mα₁₋ₓ₋ᵤMα′ₓMα″ᵤGa_{1-y-v}Mβ′_{y}Mβ″ᵥO_{3-w} (Ie),
corresponding to formula (I), in which Mβ represents a gallium atom.

26. The organized assembly based on superposed layers of materials of similar chemical nature, as defined in claim 25, in which compound (C₁) is chosen:
a) from compounds of formula (If):
La₁₋ₓ₋ᵤSrₓMα″ᵤFe_{1-y-v}Mβ′_{y}Mβ″ᵥO_{3-w} (If),
corresponding to formula (I) in which Mα represents a lanthanum atom, Mα′ represents a strontium atom and Mβ represents an iron atom;
b) from compounds of formula (Ig):
La₁₋ₓ₋ᵤSrₓMα″ᵤTi_{1-y-v}Mβ′_{y}Mβ″ᵥO_{3-w} (Ig),
corresponding to formula (I) in which Mα represents a lanthanum atom, Mα′ represents a strontium atom and Mβ represents a titanium atom; or
c) from compounds of formula (Ih):
La₁₋ₓ₋ᵤSrₓMα″ᵤGa_{1-y-v}Mβ′_{y}Mβ″ᵥO_{3-w} (Ih),
corresponding to formula (I) in which Mα represents a lanthanum atom, Mα′ represents a strontium atom and Mβ represents a gallium atom;
d) from compounds of formula (Ii):
La₁₋ₓ₋ᵤMα′ₓAlᵤFe_{1-y-v}Mβ′_{y}Mβ″ᵥO_{3-w} (Ii),
corresponding to formula (Ia) in which Mα″ represents an aluminium atom and Mβ represents an iron atom;
e) from compounds of formula (Ij):
La₁₋ₓ₋ᵤCaₓMα″ᵤFe_{1-y-v}Mβ′_{y}Mβ″ᵥO_{3-w} (Ij),
corresponding to formula (Ia) in which Mα′ represents a calcium atom and Mβ represents an iron atom; or
f) from compounds of formula (Ik):
La₁₋ₓ₋ᵤBaₓMα″ᵤFe_{1-y-v}Mβ′_{y}Mβ″ᵥO_{3-w} (Ik),
corresponding to formula (Ia) in which Mα′ represents a barium atom and Mβ represents an iron atom.

27. The organized assembly based on superposed layers of materials of similar chemical nature, as defined in claim 26, in which compound (C₁) is chosen from those of formulae:
a) La₁₋ₓ₋ᵤSrₓAlᵤFe_{1-y}Ti_{y}O_{3-w}, La₁₋ₓ₋ᵤSrₓCaᵤFe_{1-y}Ti_{y}O_{3-w}, La₁₋ₓ₋ᵤSrₓBaᵤFe_{1-y}Ti_{y}O_{3-w},
b) La₁₋ₓ₋ᵤSrₓAlᵤFe_{1-y}GaᵥO_{3-w}, La₁₋ₓ₋ᵤSrₓCaᵤFe_{1-y}l Ga_{y}O_{3-w}, La₁₋ₓ₋ᵤSrₓBaᵤFe_{1-y}Ga_{y}O_{3-w},
c) La₁₋ₓSrₓFe_{1-y}Ti_{y}O_{3-w}, La₁₋ₓSrₓFe_{1-y}Ga_{y}O_{3-w}, La₁₋ₓ₋ᵤSrₓCaᵤFeO_{3-w}, La₁₋ᵤCaᵤFeO_{3-w, or}
d) La₁₋ₓSrₓFeO_{3-w},
and more particularly those of formulae:
e) La_{0.6}Sr_{0.4}Fe_{0.9}Ga_{0.1}O_{3-w}, or La_{0.5}Sr_{0.5}Fe_{0.9}Ti_{0.1}O_{3-w}.

28. The organized assembly based on superposed layers of materials of similar chemical nature, as defined in claim 22, in which compound (C₃) is chosen:
a) from compounds of formula (IIa):
La₁₋ₓ₋ᵤMγ′ₓMγ″ᵤMδ_{1-y-v}Mδ′_{y}Mδ″ᵥO_{3-w} (IIa),
corresponding to formula (II) in which Mγ represents a lanthanum atom;
b) from compounds of formula (IIb):
Mγ₁₋ₓ₋ᵤSrₓMγ″ᵤMδ_{1-y-v}Mδ′_{y}Mδ″ᵥO_{3-w} (IIb),
corresponding to formula (II) in which Mα′ represents a strontium atom; or
c) from compounds of formula (IIc):
Mγ₁₋ₓ₋ᵤMγ′ₓMα″ᵤFe_{1-y-v}Mδ′_{y}Mδ″ᵥO_{3-w} (IIc),
corresponding to formula (II) in which Mδ represents an iron atom.

29. The organized assembly based on superposed layers of materials of similar chemical nature, as defined in claim 28, in which compound (C₃) is chosen:
a) from compounds of formula (lid):
La₁₋ₓ₋ᵤSrₓMγ″ᵤFe_{1-y-v}Mδ′_{y}Mδ″ᵥO_{3-w} (IId),
corresponding to formula (IIa) in which Mγ′ represents a strontium atom and Mδ represents an iron atom;
b) from compounds of formula (IIe):
La₁₋ₓ₋ᵤMγ′ₓAlᵤFe_{1-y-v}Mδ′_{y}Mδ″ᵥO_{3-w} (IIe),
corresponding to formula (IIa) in which Mγ″ represents an aluminium atom and Mκ represents an iron atom;
c) from compounds of formula (IIf):
La₁₋ᵤSrᵤFe_{1-y}Mδ′_{y}O_{3-w} (IIf),
corresponding to formula (IIa) in which Mγ′ represents a strontium atom, Mδ represents an iron atom and x and v are equal to 0;
d) from compounds of formula (IIg):
La₁₋ᵤCaᵤFe_{1-y}Mδ′_{y}O_{3-w} (IIg),
corresponding to formula (IIa) in which Mγ′ represents a calcium atom, Mδ represents an iron atom and x and v are equal to 0;
e) from compounds of formula (IIh):
La₁₋ᵤBaᵤFe_{1-y}Mδ′_{y}O_{3-w} (IIh),
corresponding to formula (IIa) in which Mγ′ represents a barium atom, Mδ represents an iron atom and x and v are equal to 0;
f) from compounds of formula (IIi):
La₁₋ₓ₋ᵤSrₓCa″ᵤFe_{1-y-v}Mδ′_{y}Mδ″ᵥO_{3-w} (IIi),
corresponding to formula (IId) in which Mγ″ represents a calcium atom; or
g) from compounds of formula (IIj):
La₁₋ₓ₋ᵤSrₓBaᵤFe_{1-y-v}Mδ′_{y}Mδ″ᵥO_{3-w} (IIi)
corresponding to formula (IId) in which Mγ″ represents a barium atom.

30. The organized assembly based on superposed layers of materials of similar chemical nature, as defined in claim 29, in which compound (C₃) is chosen from compounds of formulae:
a) La₁₋ₓSrₓFe_{1-y}GaᵥO_{3-w}, La₁₋ₓSrₓFe_{1-y}Ti_{y}O_{3-w}, La₁₋ₓSrₓFeO_{3-w}, La₁₋ᵤCaᵤFe_{1-y}GaᵥO_{3-w},
b) La₁₋ᵤCaᵤFe_{1-y}Ti_{y}O_{3-w}, La₁₋ᵤCaᵤFeO_{3-w}, La₁₋ᵤBaᵤFe_{1-y}GaᵥO_{3-w}, La₁₋ᵤBaᵤFe_{1-y}Ti_{y}O_{3-w},
c) La₁₋ᵤBaᵤFeO_{3-w, L}₁₋ₓ₋ᵤSrₓAlᵤFe_{1-y}Ti_{y}O_{3-w}, La₁₋ₓ₋ᵤSrₓCaᵤFe_{1-y}Ti_{y}O_{3-w},
d) La₁₋ₓ₋ᵤSrₓBaᵤFe_{1-y}Ti_{y}O_{3-w}, La₁₋ₓ₋ᵤSrₓAlᵤFe_{1-y}GaᵥO_{3-w}, La₁₋ₓ₋ᵤSrₓCaᵤFe_{1-y}Ga_{y}O_{3-w},
e) La₁₋ₓ₋ᵤSrₓBaᵤFe_{1-y}GaᵥO_{3-w}, La₁₋ₓSrₓFe_{1-y}Ti_{y}O_{3-w, La}₁₋ᵤCaᵤFe_{1-y}Ti_{y}O_{3-w},
f) La₁₋ᵤBaᵤFe_{1-y}Ti_{y}O_{3-w}, La₁₋ₓSrₓFe_{1-y}GaᵥO_{3-w}, La₁₋ᵤCaᵤFe_{1-y}GaᵥO_{3-w}, and
g) La₁₋ᵤBaᵤFe_{1-y}GaᵥO_{3-w}, La₁₋ᵤBaᵤFeO_{3-w}, La₁₋ᵤCaᵤFeO_{3-w}, or La₁₋ₓSrₓFeO_{3-w},
and more particularly those of formulae:
h) La_{0.6}Sr_{0.4}Fe_{0.9}Ga_{0.1}O_{3-w}, La_{0.9}Sr_{0.1}Fe_{0.9}Ga_{0.1}O_{3-w}, La_{0.5}Sr_{0.5}Fe_{0.9}Ti_{0.1}O_{3-w}, and
i) La_{0.9}Sr_{0.1}Fe_{).9}Ti_{0.1}O_{3-w}, La_{0.8}Sr_{0.4}Fe_{0.2}Co_{0.8}O_{3-w} or La_{0.9}Sr_{0.1}Fe_{0.2}Co_{0.8}O_{3-w}.

31. The organized assembly based on superposed layers of materials of similar chemical nature, as defined in claim 22, in which compound (C₅) is chosen:
a) from compounds of formula (IIIa):
Mε₁₋ₓ₋ᵤMε′Mε″ᵤMη_{1-y-v}Ni_{y}RhᵥO_{3-w} (IIIa)
corresponding to formula (III) in which Mη′, represents a nickel atom and Mη″ represents a rhodium atom; or
b) from compounds of formula (IIIb):
La₁₋ₓ₋ᵤSrₓMε″ᵤFe_{1-y-v}Mη′_{y}Mη″ᵥO_{3-w} (IIIb)
corresponding to formula (III) in which Mε represents a lanthanum atom, Mε′ represents a strontium atom and Mη represents an iron atom.

32. The organized assembly based on superposed layers of materials of similar chemical nature, as defined in claim 31, in which compound (C₅) is chosen from compounds of formulae:
a) La₁₋ₓCeₓFe_{1-y}Ni_{y}RhᵥO_{3-w}, La₁₋ₓCeₓFe_{1-y}Ni_{y}O_{3-w}, La₁₋ₓSrₓFe_{1-y}Ni_{y}RhᵥO_{3-w}, and
b) La₁₋ₓSrₓFe_{1-y}Ni_{y}O_{3-w},
and more particularly those of formulae:
c) La_{0.8}Ce_{0.2}Fe_{0.65}Ni_{0.3}Rh_{0.05}O_{3-w}, La_{0.8}Ce_{0.2}Fe_{0.7}Ni_{0.3}O_{3-w}, La_{0.8}Sr_{0.2}Fe_{0.65}Ni_{0.30}Rh_{0.05}O_{3-w}, and
d) La_{0.8}Sr_{0.2}Fe_{0.7}Ni_{0.3}O_{3-w}.

33. The organized assembly based on superposed layers of materials of similar chemical nature, as defined in claim 22, in which compound (C₇) is chosen:
a) from compounds of formula (IVa):
La₁₋ₓ₋ᵤMθ′ₓMθ″ᵤMκ_{1-y-v}Mκ′_{y}Mκ″ᵥO_{3-δ} (IVa),
corresponding to formula (IV) in which Mθ represents a lanthanum atom;
b) from compounds of formula (IVb):
Mθ₁₋ₓ₋ᵤSrₓMθ″ᵤMκ_{1-y-v}Mκ′_{y}Mκ″ᵥO_{3-δ} (IVb),
corresponding to formula (IV) in which Mθ′ represents a strontium atom; or
c) from compounds of formula (IVc):
Mθ₁₋ₓ₋ᵤMθ′ₓMθ″ᵤFe_{1-y-v}Mκ′_{y}Mκ″ᵥO_{3-δ(IVc),}
corresponding to formula (IV) in which Mκ represents an iron atom.

34. The organized assembly based on superposed layers of materials of similar chemical nature, as defined in claim 33, in which compound (C₇) is chosen:
a) from compounds of formula (IVd):
and Mκ represents an iron atom;
b) from compounds of formula (IVe):
La₁₋ₓ₋ᵤMθ′ₓAlᵤFe_{1-y-v}Mκ′_{y}Mκ″ᵥO_{3-w} (IVe),
corresponding to formula (IVa) in which Mθ represents an aluminium atom and Mκ represents an iron atom;
c) from compounds of formula (IVf):
La₁₋ᵤSrₓFe_{1-y}Mκ′_{y}O_{3-w} (IVf),
corresponding to formula (IVa) in which Mθ represents a strontium atom, Mκ represents an iron atom and x and v are equal to 0;
d) from compounds of formula (IVg):
La₁₋ᵤCaᵤFe_{1-y}Mκ′_{y}O_{3-w} (IVg),
corresponding to formula (IVa) in which Mθ represents a calcium atom, Mκ represents an iron atom and x and v are equal to 0;
e) from compounds of formula (IVh):
La₁₋ᵤBaᵤFe_{1-y}Mκ′_{y}O_{3-w} (IVh),
corresponding to formula (IVa) in which Mθ′ represents a barium atom, Mκ represents an iron atom and x and v are equal to 0;
f) from compounds of formula (IVi):
La₁₋ₓ₋ᵤSrₓCa″ᵤFe_{1-y-v}Mκ′_{y}Mκ″ᵥO_{3-w} (IVi),
corresponding to formula (IVh) in which Mθ″ represents a calcium atom; or
g) from compounds of formula (IVj):
La₁₋ₓ₋ᵤSrₓBaᵤFe_{1-y-v}Mκ′_{y}Mκ″ᵥO^{3-w} (IVj),
corresponding to formula (IVd) in which Mθ″ represents a barium atom.

35. The organized assembly based on superposed layers of materials of similar chemical nature, as defined in claim 34, in which compound (C₇) is chosen from compounds of formula:
a) La₁₋ₓSrₓFe_{1-y}GaᵥO_{3-w}, La₁₋ₓSrₓFe_{1-y}Ti_{y}O_{3-w}, La₁₋ₓSrₓFeO_{3-w}, La₁₋ᵤCaᵤFe_{1-y}GaᵥO_{3-w},
b) La₁₋ᵤCaᵤFe_{1-y}Ti_{y}O_{3-w}, La₁₋ᵤCaᵤFeO_{3-w}, La₁₋ᵤBaᵤFe_{1-y}Ti_{y}O_{3-w}, or
c) La₁₋ᵤBaᵤFeO_{3-w}, La₁₋ₓ₋ᵤSrₓAlᵤFe_{1-y}Ti_{y}O_{3-w}, La₁₋ₓ₋ᵤSrₓCaᵤFe_{1-y}Ti_{y}O_{3-w},
d) La₁₋ₓ₋ᵤSrₓBaᵤFe_{1-y}Ti_{y}O_{3-w}, La₁₋ₓ₋ᵤSrₓAlᵤFe_{1-y}GaᵥO_{3-w}, La₁₋ₓ₋ᵤSrₓCaᵤFe_{1-y}GaᵥO_{3-w},
e) La₁₋ₓ₋ᵤSrₓBaᵤFe_{1-y}GaᵥO_{3-w}, La₁₋ₓSrₓFe_{1-y}Ti_{y}O_{3-w}, La₁₋ᵤCaᵤFe_{1-y}Ti_{y}O_{3-w} or
f) La₁₋ᵤBaᵤFe_{1-y}Ti_{y}O_{3-w}, La₁₋ᵤCaᵤFe_{1-y}GaᵥO_{3-w}, La₁₋ᵤBaᵤFe_{1-y}gaᵥO_{3-w}, La₁₋ᵤBaᵤFeO_{3-w}, La₁₋ᵤCaᵤFeO_{3-w} or La₁₋ₓSrₓFeO_{3-w}, and more particularly those of formula:
g) La_{0.6}Sr_{0.4}Fe_{0.9}Ga_{0.1}O_{3-w}, La_{0.9}Sr_{0.1}Fe_{0.9}Ga_{0.1}O_{3-w}, La_{0.5}Sr_{0.5}Fe_{0.9}Ti_{0.1}O_{3-w}, and
h) La_{0.9}Sr_{0.1}Fe_{0.9}Ti^{0.1}O_{3-w}, La_{0.6}Sr_{0.4}Fe_{0.2}Co_{0.8}O_{3-w} or La_{0.9}Sr_{0.1}Fe_{O.2}Co_{0.8}O_{3-w}.

36. The organized assembly based on superposed layers, as defined in claim 22, wherein it comprises: either:
a) dense layer (CD₁), of thickness E_{D1}, as defined above;
b) porous layer (C_{P1}), of thickness E_{P1}, as defined above, adjacent to the said dense layer (C_{D1}); and
c) a catalytic layer (C_{C1}), of thickness E_{C1}, as defined above, in which:
i) Mα and Mβ, actually present in compound (C₁), are respectively identical to Mκ and Mη, actually present in compound (C₅); and
ii) Mα and Mβ, actually present in compound (C₁), are respectively identical to Mγ and Mδ, actually present in compound (C₃); or:
a) dense layer (CD₁), of thickness E_{D1}, as defined above;
b) a porous layer (C_{P1}), of thickness E_{P1}, as defined above, adjacent to the said dense layer (C_{D1});
c) a catalytic layer (C_{C1}), of thickness E_{C1}, as defined above; and
d) a second porous layer (CP₂), of thickness E_{P2}, in which:
i) Mθ and Mκ, actually present in compound (C₇), are respectively identical to Mε and Mη, actually present in compound (C₅);
ii) Mα and Mβ, actually present in compound (C₁), are respectively identical to Mθ and Mκ, actually present in compound (C₇); and
iii) Mα and Mβ, actually present in compound (C₁), are respectively identical to Mγ and Mδ, actually present in compound (C₃).

37. The organized assembly based on superposed layers, as defined in claim 36, wherein it comprises: either:
a) a dense layer (C_{D1}), of thickness E_{D1}, as defined above;
b) a porous layer (C_{P1}), of thickness E_{P1}, as defined above, adjacent to the said dense layer (C_{D1});
c) a catalytic layer (C_{C1}), of thickness E_{C1}, as defined above; in which Mα, Mε and Mγ each represent a lanthanum atom and Mθ, Mη and Mδ each represent an iron atom; or:
a) a dense layer (C_{D1}), of thickness E_{D1}, as defined above;
b) a porous layer (C_{P1}), of thickness E_{P1}, as defined above, adjacent to the said dense layer (C_{D1});
c) a catalytic layer (C_{C1}), of thickness E_{C1}, as defined above;
d) and a second porous layer (CP₂), of thickness EP₂, in which Mθ, Mα, Mε, and Mγ each represent a lanthanum atom and Mκ, Mβ, Mη, and Mδ each represent an iron atom.

38. The organized assembly based on superposed layers of materials of similar chemical nature, as defined in claim 22, wherein it comprises: either:
a) a dense layer (C′_{D1}) corresponding to the layer (C_{D1}) defined above and for which the material (A_{D1}) comprises, per 100% of its volume:
i) at least 95% by volume and at most 100% by volume of a compound (C,) chosen from compounds of formula:
(aa) La₁₋ₓ₋ᵤSrₓAlᵤFe_{1-y}Ti_{y}O_{3-w}, La₁₋ₓ₋ᵤSrₓCaᵤFe_{1-y}Ti_{y}O_{3-w}, La₁₋ₓ₋ᵤSrₓBaᵤFe_{1-y}Ti_{y}O_{3-w},
(bb) La₁₋ₓ₋ᵤSrₓAlᵤFe_{1-y}GaᵥO_{3-w}, La₁₋ₓ₋ᵤSrₓCaᵤFe_{1-y}Ga_{y}O_{3-w}, La₁₋ₓ₋ᵤSrₓBaᵤFe_{1-y}Ga_{y}O_{3-w},
(cc) La₁₋ₓSrₓFe_{1-y}Ti_{y}O_{3-w}, La₁₋ₓSrₓFe_{1-y}GaᵥO_{3-w}, La₁₋ₓ₋ᵤSrₓCaᵤFeO_{3-w}, La₁₋ᵤCaᵤFeO_{3-w} or
(dd) L₁₋ₓSrₓFeO_{3-w},
in which:
0<x≦0.5;
0≦u≦0.5;
(x+u)≦0.5;
0≦y≦0.9;
0≦v≦0.9; 0≦(y+v)≦0.9; and
w is such that the structure in question is electrically neutral;
ii) optionally up to 5% by volume of a compound (C₂), which differs from compound (C₁), as defined above; and
iii) optionally up to 0.5% by volume of a compound (C₁₋₂) produced from at least one chemical reaction represented by the equation:
xF_{C1}+yF_{C2}→zF_{C1-2},
in which equation F_{C1}, F_{C2}, and F_{C1-2}, represent the respective raw formulae of compounds (C₁), (C₂), and (C₁₋₂), and x, y, and z represent rational numbers greater than or equal to 0;
b) a porous layer (C′_{P1}) corresponding to layer (C_{P1}) defined above, for which the material (A_{P1}) comprises, per 100% of its volume:
i) at least 95% by volume and at most 100% by volume of a compound (C₃) chosen from compounds of formula:
(aa) La₁₋ₓSrₓFe_{1-y}GaᵥO_{3-w}, La₁₋ₓSrₓFe_{1-y}Ti_{y}O_{3-w}, La₁₋ₓSrₓFeO_{3-w}, La₁₋ᵤCaᵤFe_{1-y}GaᵥO_{3-w}, La₁₋ᵤCaᵤFe_{1-y}Ti_{y}O_{3-w}, La₁₋ᵤCaᵤFeO_{3-w}, La₁₋ᵤBaᵤFe_{1-y}GaᵥO_{3-w}, La₁₋ᵤBaᵤFe_{1-y}Ti_{y}O_{3-w},
(bb) La₁₋ᵤBaᵤFeO_{3-w}, La₁₋ₓ₋ᵤSrₓAlᵤFe_{1-y}Ti_{y}O_{3-w}, La₁₋ₓ₋ᵤSrₓCaᵤFe_{1-y}Ti_{y}O_{3-w},
(cc) L₁₋ₓ₋ᵤSrₓBaᵤFe_{1-y}Ti_{y}O_{3-w}, La₁₋ₓ₋ᵤSrₓAlᵤFe_{1-y}GaᵥO_{3-w}, La₁₋ₓ₋ᵤSrₓCaᵤFe_{1-y}GaᵥO_{3-w}, or
(dd) La₁₋ₓ₋ᵤSrₓBaᵤFe_{1-y}GaᵥO_{3-w}, in which:
0<x≦0.5;
0≦u≦0.5;
(x+u)≦0.5;
0≦y≦0.9;
0≦v≦0.9; 0≦(y+v)≦0.9; and
w is such that the structure in question is electrically neutral;
ii) optionally up to 5% by volume of a compound (C₄), which is different from compound (C₃), as defined above; and
iii) optionally up to 0.5% by volume of a compound (C₃₋₄) produced from at least one chemical reaction represented by the equation:
xF_{C3}+yF_{C4}→zF_{C3-4},
in which equation F_{C3}, F_{C4}, and F_{C3-4}, represent the respective raw formulae of compounds (C₃), (C₄), and (C₃₋₄), and x, y, and z represent rational numbers greater than or equal to 0;
c) and a catalytic layer (C′_{C1}) corresponding to layer (C_{C1}) defined above, for which the material (A_{C1}) comprises, per 100% of its volume:
i) at least 95% by volume and at most 100% by volume of a compound (C₅) chosen from compounds of formula:
(aa) La₁₋ₓCeₓFe_{1-y-v}Ni_{y}RhᵥO_{3-w}, La₁₋ₓCeₓFe_{1-y}Ni_{y}O_{3-w}, La₁₋ₓSrₓFe_{1-y-v}Ni_{y}RhᵥO_{3-w}, and
(bb) La₁₋ₓSrₓFe_{1-y}Ni_{y}O_{3-w}, in which:
0<x≦0.5;
0≦y≦0.7;
0≦v≦0.5;
0≦(y+v)≦0.8; and
w is such that the structure in question is electrically neutral;
ii) optionally up to 5% by volume of a compound (C₆), which is different from compound (C₅), as defined above; and
iii) optionally up to 0.5% by volume of a compound (C₅₋₆) produced from at least one chemical reaction represented by the equation:
xF_{C5}+yF_{C6}→zF_{C5-6},
in which equation F_{C5}, F_{C6}, and F_{C5-6}, represent the respective raw formulae of compounds (C₅), (C₆), and (C₅₋₆), and x, y, and z represent rational numbers greater to or equal to 0; or:
a) a dense layer (C′_{D1}), as defined above;
b) a porous layer (C′_{P1}), as defined above;
c) a catalytic layer (C′_{C1}), as defined above;
d) and a second porous layer (C′_{P1}) corresponding to layer (C_{P2}) defined above, for which the material (A_{P2}) comprises, per 100% of its volume:
i) at least 95% by volume and at most 100% by volume of a compound (C₇) chosen from compounds of formula:
(aa) La₁₋ₓSrₓFe_{1-y}GaᵥO_{3-w}, La₁₋ₓSrₓFe_{1-y}Ti_{y}O_{3-w}, La₁₋ₓSrₓFeO_{3-w}, La₁₋ᵤCaᵤFe_{1-y}GaᵥO_{3-w},
(bb) La₁₋ᵤCaᵤFe_{1-y}Ti_{y}O_{3-w}La₁₋ᵤCaᵤFeO_{3-w}, La₁₋ᵤBaᵤFe_{1-y}GaᵥO_{3-w}, La₁₋ᵤBaᵤFe_{1-y}Ti_{y}O_{3-w},
(cc) La₁₋ᵤBaᵤFeO_{3-w}, La₁₋ₓ₋ᵤSrₓAlᵤFe_{1-y}Ti_{y}O_{3-w}, La₁₋ₓ₋ᵤSrₓCaᵤFe_{1-y}Ti_{y}O_{3-w},
(dd) La₁₋ₓ₋ᵤSrₓBaᵤFe_{1-y}Ti_{y}O_{3-w}, La₁₋ₓ₋ᵤSrₓAlᵤFe_{1-y}GaᵥO_{3-w}, La₁₋ₓ₋ᵤSrₓCaᵤFe_{1-y}GaᵥO_{3-w}, or
(ee) La₁₋ₓ₋ᵤSrₓBaᵤFe_{1-y}GaᵥO_{3-w}, in which:
0<x≦0.5;
0≦u≦0.5;
(x+u)≦0.5;
0≦y≦0.9;
0≦v≦0.9; 0≦(y+v)≦0.9; and
w is such that the structure in question is electrically neutral;
ii) optionally up to 5% by volume of a compound (C₈), which differs from compound (C₇), as defined above; and
iii) optionally up to 0.5% by volume of a compound (C₇₋₈) produced from at least one chemical reaction represented by the equation:
xF_{C7}+yF_{C8}→zF_{C7-8}.
in which equation F_{C7}, F_{C8}, and F_{C7-8}, represent the respective raw formulae of compounds (C₇), (C₈), and (C₇₋₈), and x, y, and z represent rational numbers greater than or equal to 0.

39. The organized assembly based on superposed layers of materials of similar chemical nature, as defined in claim 38, wherein it comprises: either:
a) a dense layer (C″_{D1}) corresponding to layer (C′_{D1) defined above and for which the material (A}_{D1}) comprises, per 100% of its volume:
i) at least 95% by volume and at most 100% by volume of a compound (C₁) chosen from compounds of formula
(aa) La_{0.6}Sr_{0.4}Fe_{0.9}Ga_{0.1}O_{3-w}, or
(bb) La_{0.5}Sr_{0.5}Fe_{0.9}Ti_{0.1}O_{3-w};
ii) optionally up to 5% by volume of a compound (C₂), which differs from compound (C₁), as defined above; and
iii) optionally up to 0.5% by volume of a compound (C₁₋₂) produced from at least one chemical reaction represented by the equation:
xF_{C1}+yF_{C2}→zF_{C1-2},
in which equation F_{C1}, F_{C2}, and F_{C1-2}. represent the respective raw formulae of compounds (C₁), (C₂), and (C₁₋₂), and x, y, and z represent rational numbers greater than or equal to 0;
b) a porous layer (C″_{P1}) corresponding to layer (C′_{P1}) defined above for which the material (A_{P1}) comprises, per 100% of its volume:
i) at least 95% by volume and at most 100% by volume of a compound (C₃) chosen from compounds of formula:
(aa) La_{0.6}Sr_{0.4}Fe_{0.9}Ga_{0.1}O_{3-w}, La_{0.9}Sr_{0.1}Fe_{0.9}Ga_{0.1}O_{3-w}, La_{0.5}Sr_{0.5}Fe_{0.9}Ti_{0.1}O_{3-w}, or
(bb) La_{0.9}Sr_{0.5}Fe_{0.9}Ti_{0.1}O_{3-w}, La_{0.6}Sr_{0.4}Fe_{0.2}Co_{0.8}O_{3-w} or La_{0.9}Sr_{0.1}Fe_{0.2}Co_{0.8}O_{3-w};
ii) optionally up to 5% by volume of a compound (C₄), which differs from compound (C₃), as defined above; and
iii) optionally up to 0.5% by volume of a compound (C₃₋₄) produced from at least one chemical reaction represented by the equation:
xF_{C3}+yF_{C4}→zF_{C3-4},
in which equation F_{C3}, F_{C4}, and F_{C3-4}, represent the respective raw formulae of compounds (C₃), (C₄), and (C_{3-4), and x, y, and z represent rational numbers greater than or equal to} 0; and
c) and a catalytic layer (C″_{C1}) corresponding to layer (C′_{C1}) defined above, for which the material (A_{C1}) comprises, per 100% of its volume:
i) at least 95% by volume and at most 100% by volume of a compound (C₅) chosen from compounds of formula
(aa) Ce_{0.2}Fe_{0.65}Ni_{0.30}Rh_{0.05}O_{3-w}, La_{0.8}Ce_{0.2}Fe_{0.7}Ni_{0.3}O_{3-w}, La_{0.8}Sr_{0.2}Fe_{0.65}Ni_{0.30}Rh_{0.05}O_{3-w}, and
(bb) La_{0.8}Sr_{0.2}Fe_{0.7}Ni_{0.3}O_{3-w};
ii) optionally up to 5% by volume of a compound (C₆), which differs from compound (C₅), as defined above; and
iii) optionally up to 0.5% by volume of a compound (C₅₋₆) produced from at least one chemical reaction represented by the equation:
xF_{C5}+yF_{C6}→zF_{C5-6},
in which equation F_{C5}, F_{C6}, and F_{C5-6}, represent the respective raw formulae of compounds (C₅), (C₆), and (C₅₋₆), and x, y, and z represent rational numbers of greater than or equal to 0; or:
a) a dense layer (C″_{D1}), as defined above;
b) a porous layer (C″_{P1}), as defined above;
c) a catalytic layer (C″_{C1}), as defined above;
d) and a second porous layer (C″_{P2}) corresponding to layer (C′_{P2}) defined above, for which the material (A_{P2}) comprises, for 100% of its volume: compound (C₇) chosen from compounds of formula
(aa) La_{0.6}Sr_{0.4}Fe_{0.9}Ga_{0.1}O_{3-w}, La_{0.9}Sr_{0.1}Fe_{0.9}Ga_{0.1}O_{3-w}, La_{50.}Sr_{0.5}Fe_{0.9}Ti_{0.1}O_{3-w}, La_{0.9}Sr_{0.1}Fe_{0.9}Ti_{0.1}O_{3-w}, La_{0.6}Sr_{0.4}Fe_{0.2}Co_{0.8}O_{3-w}, or
(bb) La_{0.9}Sr_{0.1}Fe_{0.2}Co_{0.8}O_{3-w}.
ii) optionally up to 5% by volume of a compound (C₈), which differs from compound (C₇), as defined above; and
iii) optionally up to 0.5% by volume of a compound (C₇₋₈) produced from at least one chemical reaction represented by the equation:
xF_{C7}+yF_{C8}→zF_{C7-8},
in which equation F_{C7}, F_{C8}, and F_{C7-8}, represent the respective raw formulae of compounds (C₇), (C₈), and (C₇₋₈), and x, y, and z represent rational numbers greater than or equal to 0.

40. The organized assembly based on superposed layers of materials of similar chemical nature, as defined in claim 22, wherein the materials (A_{D1}), (A_{P1}), (A_{C1}) and, where appropriate, (AP₂) and, when they are present, the respective compounds (C₂), (C₄), and (C₈) are chosen independently of one another from magnesium oxide (MgO), calcium oxide (CaO), aluminium oxide (Al₂O₃), zirconium oxide (ZrO₂), titanium oxide (TiO₂), strontium-aluminium mixed oxides SrAl₂O₄ or Sr₃Al₂O₆, barium-titanium mixed oxide (BaTiO₃), calcium-titanium mixed oxide (CaTiO₃), La_{0.5}Sr_{0.5}Fe_{0.9}Ti_{0.1}O_{3-ω}or La_{0.6}Sr_{0.4}Fe_{0.9}Ga_{0.1}O₃₋₁₀₇.

41. A reactor of internal volume V, intended for the production of syngas by the oxidation of natural gas, wherein it comprises either an organized assembly of tubular form, based on superposed layers of materials of similar chemical nature, as defined in claim 22, in which the catalytic layer (C_{C1}), capable of promoting the reaction of methanoxidation by gaseous oxygen to carbon monoxide, is located on the external surface of the said assembly of tubular form closed at one of its ends, or a combination of several of these said assemblies of tubular form that are mounted in parallel, which is wherein the free volume V_{f} inside the reactor is greater than or equal to 0.25V and is preferably greater than or equal to 0.5V.

42. The reactor as defined in claim 41, in which a non-zero fraction of the volume V_{f} contains a steam-reforming catalyst.
